(19) United States
(12) Patent Application Publication
(10) Pub. No.: US 2025/0173376 A1
(43) Pub. Date: May 29, 2025

(54) METHOD AND COMPUTING NODE ENTITY FOR PROCESSING NEW VERTICES IN A DIRECTED ACYCLIC GRAPH-BASED DISTRIBUTED LEDGER

(71) Applicant: US DLT Holding LLC, Houston, TX (US)

(72) Inventor: Oleksandr Kuznetsov, Kharkiv (UA)

(73) Assignee: US DLT Holding LLC, Houston, TX (US)

(21) Appl. No.: 18/520,327

(22) Filed: Nov. 27, 2023

(51) Int. Cl. G06F 16/901

(52) U.S. Cl. CPC G06F 16/9024; G06F 16/27

(57) ABSTRACT

A method of processing new vertices of a directed acyclic graph, DAG, —based distributed ledger is provided. The method includes repeatedly obtaining data indicative of new vertices added or to be added to the DAG, each new vertex linking to other vertices of the DAG and added to the DAG as a source vertex. For each new vertex, source vertices of the DAG are determined, and it is also determined how the source vertices link to not yet fully confirmed vertices of the DAG. It is determined, based on the linking data, that one or more vertices are now fully confirmed, and these one or more vertices are then treated as fully confirmed when processing a next new vertex added to the DAG. Corresponding entities and computer program (products) are also provided.

### TECHNICAL FIELD

The present disclosure relates to the field of distributed ledgers maintained by a plurality of interconnected and cooperating computing nodes. In particular, the present disclosure relates to such distributed ledgers implemented based on directed acyclic graphs (DAGs), and to a method and computing node entity for processing new vertices of the DAG.

### BACKGROUND

A distributed ledger may be seen as an infrastructure that enables a database (or set of records, i.e. a ledger) of e.g. transactions to be distributed and synchronized across a network of nodes, such as in a peer-to-peer network. The network and the computing nodes participating therein together ensure that updates to the database are valid and made known to each participating node, and may thereby at least in theory eliminate a need for a central authority and thus also the risk of having a central point of failure. To guarantee that the database is properly synchronized, consensus among the participating nodes is often required before an update is accepted, such as the addition of a transaction or similar. Various mechanisms may be used to achieve such consensus depending on the specific type of distributed ledger technology (DLT) that is used, but often relies on some form of proof-of-work and/or proof-or-stake, and cryptography is often also used to prevent malicious actors from manipulating the distributed ledger in their favor.

Examples of distributed ledgers are e.g. Blockchain, Hashgraph, Holochain, and directed acyclic graphs (DAGs), and applications formed based upon such distributed ledgers include e.g. various cryptocurrencies, systems for trading of securities, smart contracts, non-fungible tokens (NFT), distributed data storage systems, and similar.

DAG-based distributed ledgers provide an alternative to the more traditional Blockchain architecture, and is believed to offer an improved performance in terms of e.g. an increased maximum rate of new transactions that may be processed by the network and an increased scalability. One example includes the cryptocurrency IOTA operated by the IOTA Foundation, wherein the DAG-based distributed ledger upon which IOTA relies is known under the moniker “the Tangle”.

Serving as an example of contemporary DAG-based DLT, IOTA/Tangle is at its current stage of development not fully decentralized and requires a so-called “coordinator node” (operated by the IOTA foundation) which repeatedly issues so-called milestone transactions that are used by the other participating nodes for validation purposes. Reasons for why such a coordinator node is needed includes e.g. a computational difficulty of efficiently calculating so-called confirmation confidence for vertices of the Tangle, in order to estimate how many vertices of the Tangle that currently either directly or indirectly confirms (or validates) a particular vertex and the transaction(s) it represents. Obtaining such estimates may be important, as e.g. a merchant may require a certain minimal confirmation ratio before an alleged transaction from a customer is accepted by the merchant. This issue is believed to become even more severe as the number of incoming transactions increases, and the coordinator has been introduced as a central arbitrator at least partially to avoid individual computing nodes becoming overloaded with confirmation rate calculations as the use of the Tangle increases.

The present disclosure seeks to develop the use of DAG-based distributed ledgers in general and to mitigate one or more of the above-identified shortcomings of contemporary technology.

### SUMMARY

To at least partially overcome some or all of the above-identified shortcomings of contemporary technology, the present disclosure provides a method of processing new vertices of a directed acyclic graph (DAG)-based distributed ledger, a corresponding computing node entity, and a computer program product as defined in and by the accompanying independent claims. Various embodiments of the method, computing node entity and computer program product are defined in and by the accompanying dependent claims.

According to a first aspect, there is provided a method for processing new vertices of a DAG-based distributed ledger. The method is performed by a computing node (e.g. a computing node forming part of a peer-to-peer network on which the distributed ledger is implemented, and which assumes at least partial responsibility for maintaining the distributed ledger). Using processing circuitry of the computing node, the method includes repeatedly obtaining (e.g. receiving from a network, from local input, using a network or other input interface, or similar) data indicative of new vertices added or to be added to the DAG, wherein each new vertex directly links to one or more other vertices of the DAG and is added to the DAG as a source vertex, and wherein a source vertex is defined as a vertex that is not directly linked to from any other vertex of the DAG. The method further includes, in response to each new vertex being added to the DAG and using the processing circuitry of the computing node: determining current source vertices of the DAG after adding the new vertex; determining a linking of the current source vertices to not yet fully confirmed vertices of the DAG, wherein a vertex not being fully confirmed comprises the vertex being neither directly nor indirectly linked to from all source vertices of the DAG before adding the new vertex. The method further includes determining, based on the determined linking of the current source vertices to the not yet fully confirmed vertices, that at least one vertex of the not yet fully confirmed vertices is directly or indirectly linked to from all the determined current source vertices and, in response thereto, treating the at least one vertex as fully confirmed when processing a next new vertex added (or to be added) to the DAG.

As used herein, and as will be explained in more detail later, a “source vertex” is defined as a vertex that is not linked to from any other vertex of the DAG, i.e. a vertex having zero indegree. As also used herein, that a vertex is “fully confirmed” means that the vertex is directly or indirectly linked to from all current source vertices of the DAG. That a source vertex “indirectly links” to another vertex means that the source vertex instead links directly to an intermediate vertex that in turn links directly to the vertex, that the source vertex instead links directly to an intermediate vertex that directly links to yet another intermediate vertex that in turn links directly to the vertex, and similar. A “linking” of current source vertices to not yet fully confirmed vertices includes e.g. a list or indication of which current source vertices that directly or indirectly links to each not yet fully confirmed vertex, and/or e.g. which not yet fully confirmed vertices that are directly or indirectly linked to from each current source vertex, or similar.

The proposed method has the technical effect that it enables an improved throughput of new vertices, an improved scaling, and e.g. in that it allows to calculate the confirmation ratios for vertices quicker than if using e.g, methods based on Markov Chain Monte Carlo (MCMC) algorithms. The method also requires less computational power and memory of the computing node. This because by starting to treat a vertex as fully confirmed once it is determined to be linked to from all current source vertices of the DAG, the size of a collection of vertices that are not yet fully confirmed and for each of which calculations are thus required for each new vertex added to the DAG may be maintained approximately constant as new vertices added to the DAG are expected to arrive at a pace similar to that at which vertices become fully confirmed. In addition, the proposed method does not rely on statistics (such as if using the MCMC algorithm) in order to only estimate whether a vertex is fully confirmed or not, but can with certainty determine that such is the case which allows to move the vertex to an irrevocable part of the ledger and avoid having to take the state of the vertex into account when e.g. accessing the validity of future vertices. The proposed method thereby has the further technical effect that it enables an enhanced scaling of DAG-based DLT towards higher rates of incoming transactions (i.e., a higher rate of new vertices added to the DAG), and puts less strain in terms of computational power and memory of computational nodes involved in implementing the distributed ledger on the network, also leading to an overall improved consistency and data synchronization.

In one or more embodiments of the method, determining the linking of the current source vertices to the not yet fully confirmed vertices may include, for each of the not yet fully confirmed vertices, updating a respective unconfirmed vertex-specific linking set including indications of source vertices directly or indirectly linking to the specific not yet fully confirmed vertex. This may be achieved by replacing therein (in the unconfirmed vertex-specific linking set) indications of any of the one or more other vertices directly linked to from the new vertex with an indication of the new vertex. If the new vertex does not directly link to any vertex previously indicated in the unconfirmed vertex-specific linking set but instead directly links to the not yet fully confirmed vertex, the unconfirmed vertex-specific linking set may instead be updated by adding thereto the indication to the new vertex. As used herein, an “indication” means something which makes it possible for the computing node to identify a particular vertex of the DAG. Each vertex may for example be provided with a unique index, such as e.g. an integer or any other symbol or combination of symbols, and an indication as used herein may then include such an integer. For example, a set may e.g. be a singleton including an integer ID of a single vertex, or the set may include multiple elements each indicating a particular vertex. Consequently, an unconfirmed vertex-specific linking set may include e.g. integer IDs of all source vertices linking to the particular vertex. In other envisaged examples, instead of an integer ID of a particular vertex or similar, an indication may instead include e.g. a data object representing the vertex, or a pointer to such an object, or similar. In general, it is envisaged that an indication may include anything from which a particular vertex may be deduced, either by including the data structure/object defining the vertex itself as part of the indication, and/or by including something pointing to or identifying the vertex as part of the indication. Defining sets in order to represent one or more vertices of the DAG may have the further technical advantage that they may be easier to implement on a computing unit, e.g. as arrays in memory or similar, for which e.g. dedicated circuitry capable of performing numerically efficient and/or accurate operations are known. In addition, conventional set theory operations may also be used, and (as will be shown later herein) the use of sets may e.g. enable to more quickly and efficiently calculate e.g. confirmation ratios and sets of fully confirmed vertices. Defining and updating unconfirmed vertex-specific linking sets as described above may e.g. be particularly useful for quickly and efficiently calculating confirmation ratios.

In one or more embodiments of the method, the method may further include removing unconfirmed vertex-specific linking sets for vertices having been determined to be fully confirmed. As used herein, “removing” may e.g. include deleting from memory, or at least marking a space in memory previous occupied with storing such unconfirmed vertex-specific linking sets as available to store new, other data. Removing unconfirmed vertex-specific linking sets for now fully confirmed vertices may enable to maintain a more or less constant memory requirement as new vertices are added to the DAG, as new vertices may be assumed to arrive at a rate approximately similar to the rate at which older vertices become fully confirmed.

In one or more embodiments of the method, determining the current source vertices may include updating a source vertices set including indications of source vertices of the DAG. Updating the set may include removing therefrom indications of any of the one or more other vertices of the DAG linked to from the new vertex, and adding thereto an indication of the new vertex. Determining that the at least one vertex of the not yet fully confirmed vertices is directly or indirectly linked to from all the determined current source vertices may include at least one of: i) determining that the corresponding unconfirmed vertex-specific linking set and the source vertices set have a same cardinality, and ii) determining that the corresponding unconfirmed vertex-specific linking set and the source vertices set are equal. For example, that the sets have a same cardinality may be quicker and sufficient to decide that all current source vertices link to the particular vertex, assuming that the envisaged method has been consistent when processing earlier vertices added to the DAG. That the sets are equal (that is, have equal cardinality and the same elements) may be a definite conclusion that all current source vertices links to the particular vertex.

In one or more embodiments of the method, determining the current source vertices may include updating a source vertices set including indications of source vertices of the DAG. The set may be updated by removing therefrom indications of any of the one or more other vertices linked to from the new vertex, and adding thereto an indication of the new vertex. The method may further include determining a confirmation ratio for at least one (particular) vertex of the not yet fully confirmed vertices. Determining the confirmation ratio may include at least one of: i) determining a ratio of a cardinality of the corresponding unconfirmed vertex-specific linking set to a cardinality of the source vertices set, and ii) determining a ratio of a cardinality of an intersection of the corresponding unconfirmed vertex-specific linking set and the source vertices set to a cardinality of the source vertices set. Calculating the cardinalities of each of the two sets separately (as in option i)) may be quicker than calculating the cardinality of the intersection of the sets and the cardinality of the source vertices set, while the latter (option ii)) may provide a definite conclusion about the confirmation ratio of the particular vertex.

In one or more embodiments of the method, determining the linking of the current source vertices to the not yet fully confirmed vertices may include defining, for the new vertex, a source vertex-specific linking set including indications of all not yet fully confirmed vertices directly or indirectly linked to from the new vertex. In some embodiments, such sets may be created and stored for each new vertex added to the DAG, and may in some examples also reference/indicate one or more vertices that have become fully confirmed. As will be illustrated in more detail herein, it may be envisaged that at least part of such sets will not change as new vertices are added to the DAG, in which case the sets may be stored more efficiently, e.g. by only storing the parts that are still changing as new vertices are added, and/or by e.g. using various compression techniques making use of some data of the sets remaining unchanged as new vertices are added to the DAG. Defining and updating source vertex-specific linking sets as described above may e.g. be particularly useful for quickly and efficiently calculating/finding sets of fully confirmed vertices.

In one or more embodiments of the method, the source vertex linking set for the new vertex may be defined by adding indications of the one or more other vertices directly linked to from the new vertex to a union of corresponding source vertex linking sets for the one or more other vertices. As the envisaged method recites repeatedly receiving and processing new vertices, it may be assumed that the corresponding source vertex linking sets have thus been created and stored at an earlier stage, e.g. when the corresponding vertices to which the new vertex directly links were themselves added to the DAG as new vertices. Using set operations on e.g. binary numbers used to store the sets may be particularly effective computationally.

In one or more embodiments of the method, the method may further include removing (as described above) source vertex-specific linking sets for one or more previous source vertices directly linked to from the new vertex, e.g. as these one or more other vertices become fully confirmed or similar, with the advantage of maintaining an approximately constant memory requirement as described earlier herein.

In one or more embodiments of the method, determining that the at least one vertex of the not yet fully confirmed vertices is directly or indirectly linked to from all the determined current source vertices may include determining that the at least one vertex is indicated in a corresponding source vertex-specific linking set for each of the determined current source vertices. This may e.g. provide a quick and efficient way to find out whether a particular vertex is fully confirmed or not.

In one or more embodiments of the method, the method may further include determining a confirmation ratio for at least one vertex of the not yet fully confirmed vertices. Determining the confirmation ratio may include determining a ratio of a number of corresponding source vertex-specific linking sets of the determined current source vertices in which the at least one vertex is indicated, to a total number of determined current source vertices. This may e.g. provide an alternative to/of calculating confirmation ratios for vertices.

In one or more embodiments of the method, the method may further include determining a set of fully confirmed vertices as an intersection of corresponding source vertex-specific linking sets of the determined current source vertices. This may provide a quick and efficient way of establishing which vertices that are fully confirmed, using e.g. set operations and in particular if using binary numbers to represent and store the various sets.

In one or more embodiments of the method, source vertices of the DAG may be indicated using integers, such that each source vertex is provided with (or assigned) a unique integer. Each unconfirmed vertex-specific linking set may be represented as a binary number, each source vertex of the set may correspond to a particular bit of the binary number, and the particular bit may be identifiable based on the integer used to indicate the corresponding source vertex. For example, an i:th vertex may be represented by an i:th bit of a binary number. This may provide a particularly quick and efficient way of representing sets of vertices.

In one or more embodiments of the method, union and/or intersection operations involving unconfirmed vertex-specific linking sets may be performed as corresponding OR and/or AND operations on the binary numbers used to represent the sets. For example, if a set A is stored as a binary number a, and if a set B is stored as a binary number b, a union of the sets A and B may be evaluated as “a OR b”, while an intersection between the sets A and B may be evaluated as “a AND b”, and similar, thus enabling to use the capability of a computer and processing circuitry to efficiently handle binary numbers and perform bitwise operations.

In one or more embodiments of the method, not yet fully confirmed vertices of the DAG may be indicated using integers, and each vertex may be provided with (or assigned) a unique such integer. Each source vertex-specific linking set may be represented as a binary number. Each not yet fully confirmed vertex of the set may correspond to a particular bit of the binary number, and the particular bit may be identifiable based on the integer used to indicate the corresponding not yet fully confirmed vertex. The advantages are similar to those described above for the source vertices and unconfirmed vertex-specific linking sets.

In one or more embodiments of the method, union and/or intersection operations involving source vertex-specific linking sets may be performed as corresponding OR and/or AND operations on the binary numbers used to represent the sets, with the same advantages as described above for the source vertices and unconfirmed vertex-specific linking sets.

In one or more embodiments of the method, the computing node may form part of a plurality of interconnected computing nodes configured to jointly implement the DAG-based distributed ledger. The computing node (as well as e.g. the other computing nodes) may operate on its own local copy of the DAG, and use various protocols to reach consensus about what the true state of the DAG is or should be.

In one or more embodiments of the method, treating the at least one vertex as fully confirmed (when processing later new vertices) may include obtaining one or more indications that the at least one vertex is also determined to be fully confirmed by at least a finite number of the plurality of computing nodes. For example, it may be decided that at least a number of other computing nodes arriving at a same conclusion must equal or exceed a predefined threshold value, a predefined ratio, or similar, in order for each computing node to start treating the at least one vertex as fully confirmed.

In one or more embodiments of the method, the method may further include, in response to determining that the at least one vertex is directly or indirectly linked to from all determined current source vertices, inserting the at least one vertex into a pool of fully confirmed vertices accessible to the plurality of computing nodes. Treating the at least one vertex as fully confirmed may be performed in response to a consensus being reached among the plurality of computing nodes about the at least one vertex being fully confirmed. The pool may e.g. be defined as some memory distributed and synchronized among the computing nodes, to which each node may suggest candidate vertices that the computing node believes to be fully confirmed.

According to a second aspect, there is provided a computing node entity for processing new vertices of a directed acyclic graph (DAG)-based distributed ledger. The computing node entity includes processing circuitry, and the processing circuitry is configured to cause the computing node entity to repeatedly obtain data indicative of new vertices added or to be added to the DAG, wherein each new vertex directly links to one or more other vertices of the DAG and is added or to be added to the DAG as a source vertex, wherein a source vertex is defined as a vertex that is not directly linked to from any other vertex of the DAG. The processing circuitry is further configured to cause the computing node entity to, in response to each new vertex being added to the DAG: —determine current source vertices of the DAG after adding the new vertex; —determine a linking of the current source vertices to not yet fully confirmed vertices of the DAG, wherein a vertex not being fully confirmed includes the vertex being neither directly nor indirectly linked to from all source vertices of the DAG before adding the new vertex, and—determine, based on the determined linking of the current source vertices to the not yet fully confirmed vertices, that at least one vertex of the not yet fully confirmed vertices is directly or indirectly linked to from all the determined current source vertices and, in response thereto, treating the at least one vertex as fully confirmed when processing a next new vertex added to the DAG.

The computing node entity is thus configured to perform the method of the first aspect.

In one or more embodiments of the computing node entity, the processing circuitry is further configured to cause the computing node entity to perform any example of the method as discussed and disclosed herein, e.g. any of the examples described with reference to the method of the first aspect.

According to a third aspect, there is provided a computer program product for processing new vertices of a directed acyclic graph (DAG)-based distributed ledger. The computer program product includes a non-transitory computer readable storage medium storing computer code which, when executed by processing circuitry of a computing node entity, causes the computing node entity to repeatedly obtain data indicative of new vertices added or to be added to the DAG, wherein each new vertex links to one or more other vertices of the DAG and is added or to be added to the DAG as a source vertex, wherein a source vertex is defined as a vertex that is not directly linked to from any other vertex of the DAG. The computer code is further configured to cause the computing node entity to, in response to each new vertex being added to the DAG: —determine current source vertices of the DAG after adding the new vertex; —determine a linking of the current source vertices to not yet fully confirmed vertices of the DAG, wherein a vertex not being fully confirmed includes the vertex being neither directly nor indirectly linked to from all source vertices of the DAG before adding the new vertex, and—determine, based on the determined linking of the current source vertices to the not yet fully confirmed vertices, that at least one vertex of the not yet fully confirmed vertices is directly or indirectly linked to from all the determined current source vertices and, in response thereto, treating the at least one vertex as fully confirmed when processing a next new vertex added to the DAG.

The computer program product is thus configured to make a computing node perform the method of the first aspect, and may also be configured to further cause the computing node to perform any embodiment of the method as described or at least envisaged herein.

As used herein, a computer-readable storage medium (such as that of e.g. the third aspect) may be non-transitory and be provided as e.g. a hard disk drive (HDD), solid state drive (SDD), USB flash drive, SD card, CD/DVD, and/or as any other storage medium capable of non-transitory storage of data. In other examples, the computer-readable storage medium may be transitory and e.g. correspond to a signal (electrical, optical, mechanical, or similar) present on e.g. a communication link, wire, or similar means of signal transferring.

Other objects and advantages of the present disclosure will be apparent from the following detailed description (of preferred examples/embodiments), the drawings and the claims. Within the scope of the present disclosure, it is envisaged that all features and advantages described with reference to e.g. the method of the first aspect are relevant for, apply to, and may be used in combination with also the computing node entity of the second aspect, and the computer program product of the third aspect, and vice versa.

### BRIEF DESCRIPTION OF THE DRAWINGS

Exemplifying embodiments will be described below with reference to the accompanying drawings, in which:

FIG. 1 schematically illustrates an example of a directed acyclic graph (DAG)-based distributed ledger as envisaged herein;

FIGS. 2A and 2B schematically illustrates flowcharts of various exemplary methods as envisaged herein;

FIGS. 3A to 3F schematically illustrates an exemplary progress of a method as envisaged herein;

FIGS. 4A and 4B schematically illustrates an exemplary computing node entity as envisaged herein;

FIGS. 5A and 5B schematically illustrates another exemplary computing node entity as envisaged herein;

FIG. 6 schematically illustrates an exemplary computer program (product) and computer readable medium as envisaged herein;

FIG. 7 schematically illustrates a system/network of interconnected computing node entities as envisaged herein, and

FIG. 8 schematically illustrates results of a validation test of a method as envisaged herein.

In the drawings, like reference numerals will be used for like elements unless stated otherwise. Unless explicitly stated to the contrary, the drawings show only such elements that are necessary to illustrate the example embodiments, while other elements, in the interest of clarity, may be omitted or merely suggested.

### DETAILED DESCRIPTION

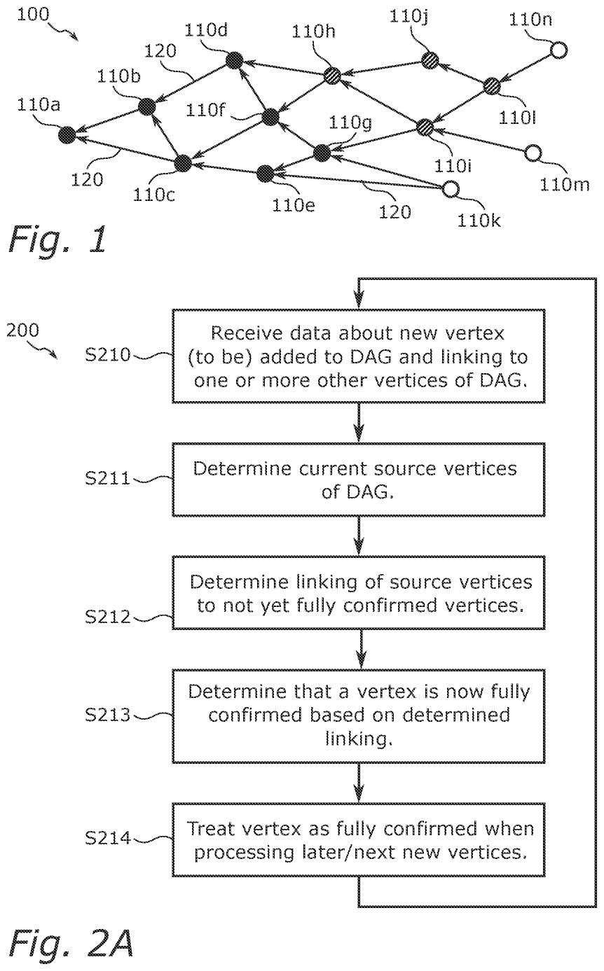

An overview of the concept of directed acyclic graphs (DAGs) and their relation to the present disclosure will now be given with reference to FIG. 1.

FIG. 1 schematically illustrates an example of a DAG 100. The DAG 100 includes a plurality of vertices 110a-110n that are connected together via a plurality of edges 120. To avoid cluttering, not all edges have been provided with the reference numeral 120. As the name implies, the edges 120 of the DAG 100 are directed, and links from one particular node to another particular node and not the other way around. For example, the edge between the vertices 110a and 110c points from the vertex 110c to the vertex 110a, meaning that the vertex 110c links to the vertex 110a. There is however no such link from the vertex 110a to the vertex 110c. As the name also implies, the edges 120 of the DAG 100 are such that the DAG 100 is acyclic, meaning that if starting at any particular vertex 110a-110m and jumping through other vertices of the DAG 100 in the direction indicated by the arrows representing the edges 120, there is no way to make a loop and once again end up at the particular vertex from which the “journey” was started. Phrased differently, if moving from one vertex to another, cycling back towards the starting vertex is not possible if following the rules of movement established by the directions of the edges 120.

For the sake of the DAG 100 as an abstract mathematical concept, the exact way in which the DAG 100 is illustrated (e.g., the exact positions of the vertices, the length of the edges, etc.) is not important, and the DAG 100 is defined solely by the collection of vertices and the edges (i.e. between which vertices there are edges, and in what direction each edge points). An indegree of a particular vertex may be defined as a number of other vertices linking to the particular vertex, i.e. as a total number of edges/arrows pointing to the particular vertex. In the DAG 100, the vertex 110a is linked to from vertices 110b and 110c, and thereby has an indegree of two. Each of the vertices 110k, 110m and 110n has, however, no other vertices linking to them, and thereby has an indegree of zero. Likewise, an outdegree of a particular vertex may be defined as a number of other vertices linked to from the particular vertex, i.e. as a total number of edges/arrows pointing from the particular vertex towards other vertices. In the DAG 100, the vertex 110a does not link to any other vertex and thereby has an outdegree of zero. The vertices 110m and 110n each have an outdegree of one as they both link to one other vertex, respectively, while the vertex 110k links to two other vertices (110e and 110g) and has an outdegree of two, etc. As will be used herein, and as used in conventional graph theory, a vertex having an indegree of zero (such as any of the vertices 110k, 110m and 110n) will be referred to as a source vertex, while a vertex having an outdegree of zero (such as the vertex 110a) may be referred to as a sink vertex.

A DAG such as the DAG 100 illustrated in FIG. 1 may also be used to form/represent a ledger, in which each vertex may represent a particular transaction (or other items of data), and wherein e.g. the location of each vertex along the horizontal axis may correspond to at which time the transaction was added to the ledger. Within this realm, the vertex 110a is defined as a so-called genesis vertex, as it was the first transaction made and thereby the first vertex added to the DAG 100. Moving from left to right, each new vertex will end up being further to the right than any previously added vertices, such that e.g. the vertex 110c is to the right of the vertex 110b as a result of the vertex 110b being added to the ledger/DAG 100 before vertex 110c, etc. A transaction may e.g. be a transfer of some quantity (such as money or other goods). For example, an individual “A” may transfer X amount of money to individual “B”, and the corresponding transaction may be recorded as “A has transferred X to B”, or similar. The transaction may e.g. be included as part of a data object used to represent a vertex, or the vertex may e.g. include at least a reference to some other data structure/source wherein transactions are stored, in order to create a link associating the vertex with a particular transaction. For example, a database may store a plurality of transactions each having their own unique ID (such as a unique integer or other combination of symbols), and a vertex representing transaction with a particular ID may thus include the particular ID reference the database. In other envisaged examples, the vertex may store all or part of the transaction data itself. In any way, exactly how the transactions are stored and where is out of the scope of the present disclosure, as long as there is at least some element stored as part of a particular vertex which may enable to identify a particular transaction and the content thereof.

A later transaction may be required to confirm (or verify) at least one earlier transaction, which may be represented in the DAG 100 as an edge linking from the vertex corresponding to the later transaction to the vertex corresponding to the earlier transaction. For example, in FIG. 1 and the DAG 100, the transaction represented by the vertex 110h confirms two earlier transactions, namely the transactions represented by vertices 110d and 110f (as indicated by the edges/arrows pointing from the vertex 110h towards each of the vertices 110d and 110f). The number of earlier transactions that each new transaction is required to verify may vary depending on the exact implementation of the ledger, but may for example correspond to e.g. one or two earlier transactions, or more. This may be particularly so when the ledger is distributed between multiple interconnected (computing) nodes on a (peer-to-peer) network, in which case the DAG 100 is said to represent/form a distributed ledger. In such a situation, and as will be elaborated on further later herein, each computing node may keep its own local copy/version of the DAG, and use various consensus mechanisms to make sure that such local copies will be properly synchronized between the computing nodes, and that transactions will be verified correctly such that conflicting transactions do not end up being stored in a version of the DAG agreed upon by all (or at least some, such as a majority) of the computing nodes.

As envisaged herein, a vertex may directly confirm another vertex, in which case there is an edge directly linking from the confirming vertex to the confirmed vertex. A vertex may also indirectly confirm another vertex, in which case there is no single edge directly between the two vertices, but wherein a chain of confirmations may be traced from the (indirectly) confirming vertex to the (indirectly) confirmed vertex. Using FIG. 1 and the DAG 100 as an example, the vertex 110g is directly confirmed by vertices 110i and 110k, and indirectly confirmed by vertices 110l (via vertex 110i), 110m (via vertex 110i), and 110n (via both of 110i and 110l). By design, the genesis (sink) vertex 110a is directly or indirectly confirmed by all other vertices of the DAG 100. Likewise, the (source) vertices 110k, 110m and 110n are neither directly nor indirectly confirmed by any other vertices of the DAG 100.

As mentioned earlier herein, one example of a distributed ledger implemented based on a DAG is IOTA by the IOTA Foundation (https://www.iota.org/), wherein the DAG is referred to as the “Tangle”. In IOTA/Tangle, source vertices such as 110k, 110m and 110n are each referred to as a “tip”. It should also be noted that the vertices of a DAG may in some situations also be referred to as “sites”, “nodes” or e.g. “points”. However, within the present disclosure, only “vertex/vertices” will be used when referring to the interconnected elements of the DAG, and “node” will e.g. instead be used to refer to a “computing node” of a network. Likewise, edges of the DAG may also be referred to as “links” or “lines”, or similar. Within the present disclosure, edges will be referred to only as “edges” and perhaps “links”. Herein, the terms “vertex” and “transaction” will also be used interchangeably, if not stated to the contrary.

The vertices and the transactions they represent may further be divided into different subclasses depending on which vertices (or transactions) confirms other vertices and how. For example, a vertex will be referred to as being fully confirmed if it is directly or indirectly linked to from all later vertices of the DAG. Due to the construction of the DAG, this is the same thing as being directly or indirectly linked to from all source vertices of the DAG, as, by design, being linked to by all source vertices of the DAG results in their always being a path available from each source vertex through any possible vertex added to the graph at a later stage than the fully confirmed vertex. In the DAG 100, the vertices 110a-110g are all considered to be fully confirmed. The vertices 110k, 110m and 110n are all source vertices, and the remaining vertices 110h, 110i, 110j and 110l are referred to as vertices which are yet to be fully confirmed. As used herein, source vertices may of course be considered as forming a subset of vertices which are yet to be fully confirmed. In FIG. 1 and DAG 100, fully confirmed vertices are illustrated using filled circles, source vertices are illustrated using empty circles, and vertices that are yet to be fully confirmed (but that are not source vertices) are illustrated using circles having a dashed filling.

The present disclosure is generally concerned with how to efficiently establish the linking between the various vertices, and in particular with how to e.g. determine whether a particular vertex is fully confirmed or not, to what degree (confirmation ratio) a particular vertex is confirmed by all source vertices, and/or which vertices that are fully confirmed or not, and similar, and how to perform such determining in a more efficient and less resource consuming way than what is contemporarily known.

As an illustration of contemporary technology, it is noted that IOTA/Tangle is concerned with what is referred to as confirmation confidence, and in particular with how such confirmation confidence may be used to combat e.g. so-called double-spending attacks or other situations wherein an individual somehow (on purpose or by mistake) manages to e.g. pay for two items from different merchants using the same money, and such that if not taking any further action, at least one of the merchants will end up not getting paid. To resolve this problem, a merchant may decide to only deliver items to an individual in response to the confirmation confidence of the corresponding transaction being sufficiently high. In brief, confirmation confidence is thus introduced in IOTA/Tangle in order to assess a particular transaction's level of acceptance by the rest of the Tangle, and is in accordance with the specifications of IOTA/Tangle calculated as follows:
i) select one particular vertex/transaction for which the confirmation confidence is to be calculated;
ii) run a so-called tip selection algorithm Nₜₒₜ times, each run generating a path from the genesis vertex to a source vertex;
iii) count how many (Nₙᵢₜ) of the Nₜₒₜ paths that passes through the particular vertex/transaction, and
iv) define the confirmation confidence 8 for the particular vertex/transaction as the proportion of the number of passing paths to the total number of generated paths, i.e. 8=Nₙᵢₜ/Nₜₒₜ.

In the above, the tip selection algorithm is based on random walks and operates by placing a “walker” on the genesis vertex of the DAG, and then causes the walker to move towards the other end of the DAG by, at each vertex it arrives at, deciding which next vertex to visit based on the edges of the DAG. Here, the walker is of course made to follow the opposite directions than those indicated by the arrows in e.g. FIG. 1. After a number of such “jumps”, the walker will eventually arrive at a vertex from which there is no further vertex to visit, i.e. the arrived-at vertex is a source vertex and the algorithm has thereby found (or selected) a particular source vertex/tip by taking a specific path from the genesis vertex to the source vertex. To run the tip selection algorithm again, the walker is once again placed at the genesis vertex, and made to select a new path through the vertices of the DAG until once again arriving at a (potentially different) source vertex, and so on. Using FIG. 1 and the DAG 100 as an example, starting from the vertex 110a, the walker may e.g. at a first try end up taking the path via vertices 110b, 110d, 110h, 110i, and 110l (in that order) before arriving at the source vertex/tip 110n. In another run, the walker may instead e.g. end up at source vertex/tip 110k after visiting vertices 110c and 110e (in that order), and so on.

When arriving at a particular vertex, the walker may have multiple possible vertices to visit next, if the particular vertex is linked to from multiple other vertices (and i.e. has a non-zero indegree). The walker may for example assign a number to each possible next vertex, and flip a multi-sided coin (or throw a corresponding dice) in order to select which vertex to jump to next. Phrased differently, an equal probability 1/Nᵢ may be assigned to all possible paths from a particular i:th vertex to a next vertex (if the indegree of the i:th vertex equals Nᵢ), and then act based on such assigned probabilities. This is referred to as an unweighted random walk. To avoid e.g. the problem of what is called “lazy tips” (i.e. source vertices which for some reason confirms only more earlier vertices than more recent vertices), the tip selection algorithm may be modified to instead use a weighted random walk. Here, the random walk performed by the walker is biased based on e.g. different weights assigned to each vertex. The weight of a particular vertex may e.g. be assigned based on how much work has been put in to add the vertex to the DAG, and a cumulative weight of a particular vertex may be based on how many other vertices that directly or indirectly confirms the particular vertex. When deciding to which vertex out of a plurality of possible vertices the walker is to jump next, the walker may, instead of assigning equal probabilities to all possible jumps, assign probabilities such that a vertex having a higher cumulative weight is more likely to be jumped to than a vertex having a lower cumulative weight.

More generally, and as proposed in IOTA/Tangle, how to select to which vertex the walker is to jump next may be decided based on a so-called Markov Chain Monte Carlo (MCMC) technique, wherein a rule is set for how to transition from one vertex to the next, and where this rule only depends on the current vertex and not on what vertices the walker previously visited during the run of the tip selection algorithm. In more detail, this is achieved by taking into account the cumulative weights of the vertices in accordance with a parameter (e.g. α), where α=0 corresponds to assigning equal probabilities to all possible jumps, where a large a corresponds to assigning unit or close to unit probability to the jump towards the vertex having the highest cumulative weight, and where a being somewhere in between zero and very large provides a possibility to tune how important the cumulative weight of each vertex are when deciding upon which vertex to jump to next.

In summary of the above, a tip selection algorithm may of course select a particular tip randomly (by e.g. rolling a dice), but such an algorithm does not offer any or much protection against e.g. lazy tips and the problem of whether the randomly selected tip actually confirms the particular vertex or not still remains. Phrased differently, if there are dishonest or otherwise malicious participants (computing nodes) with the intent to have their own transactions validated quickly without having to perform much work on their own, a strategy could include to just reference the genesis vertex (or one or more vertices close to the genesis vertex) when adding a new vertex/transaction to the DAG, as this would result in only having to validate a short chain of transactions, and the recently added vertex would more quickly be confirmed by the other computing nodes. The MCMC algorithm as described above prevents such behavior as, when running a properly tuned such MCMC algorithm, vertices of longer chains of vertices would be selected over shorter chains, and lazy vertices/tips would thus be ignored and remain unconfirmed.

As realized by the inventor, issues with using the MCMC algorithm for tip selection as part of determining e.g. the confirmation confidence are at least twofold.

First, the tip selection algorithm as proposed in e.g. IOTA/Tangle is only capable of providing a probabilistic estimate of the true confirmation ratio (that is, as defined herein, the true proportion of all current source vertices that actually directly or indirectly confirms a particular vertex). Although sometimes small, there is therefore still a possibility that an indicated confirmation confidence of 100% does not actually guarantee a true confirmation ratio of 1.0 (or 100%), which may have negative consequences. For example, if making Nₜₒₜ=100 runs of the MCMC tip selection algorithm for a particular vertex, it may be concluded that all paths (i.e. Nₕᵢₜ=Nₜₒₜ) from the genesis vertex thus generated happened to pass through the particular vertex, and that the confirmation confidence for the particular site is thus 100%. However, there is no guarantee that yet another run of the algorithm would generate a path which does not run through the particular vertex, and the use of the MCMC algorithm as part of confirmation confidence estimation is therefore not a completely reliable measure of whether a particular vertex is in fact fully confirmed or not. A particular feature of a DAG-based (distributed) ledger is that as long as there is at least one path available which does not pass through a particular vertex, there will be at least one alternative branch of the graph that could potentially contradict the main/original branch. In real life, this serves as an opportunity for a malicious participant to execute e.g. a double-spending attack. For example, the malicious participant could wait until the MCMC-based algorithm provides a high confirmation confidence (e.g. 99% or even 100%) for a particular vertex (and corresponding transaction), at which occasion a merchant would likely accept the transaction. The malicious participant may then start to intensively develop an alternative branch of the graph, i.e. a path that does not pass through the particular vertex of interest. By only referencing this additional branch and by e.g. being in control of multiple computing nodes involved in maintaining the distributed ledger, the malicious participant could thus make the confirmation ratio quickly decrease towards 0% again, and a double-spending attack would be possible. Consequently, using the MCMC-based algorithm as a probabilistic estimate of confirmation confidence (and thereby also of actual confirmation rate) would inevitably result in such double-spending attacks being possible, and is also a reason for why e.g. IOTA/Tangle has decided to use so-called coordinators which makes the decentralized ledger less decentralized and whose presence are likely to remain until the underlying framework is changed or replaced.

Secondly, the MCMC algorithm is costly in terms of computational power and memory, in particular when used to determine the confirmation confidence, and may hinder further upscaling of the distributed ledger and DAG as a result thereof. For example, for a path from the genesis vertex to a source vertex including a total of M visited vertices, one would approximately have to evaluate M×k cumulative weights (where k is an average number of links for each vertex on the path). For the MCMC algorithm to work it would be required to evaluate M×k cumulative weights, calculate M×k transition probabilities, and make M×k random transitions based on the corresponding transition probabilities. For each vertex for which the confirmation confidence is to be estimated, the algorithm would have to be run Nₜₒₜ times, resulting in [symbol] (MkNₜₒₜ) numerical operations for each vertex. IOTA/Tangle recommends that Nₜₒₜ=100 or more. Thus, for even a moderately sized DAG resulting in e.g. on average M=1000 visited vertices between the genesis vertex and a source vertex, and wherein each vertex on average links to k=2 other vertices, several hundred thousand numerical operations would have to be performed for each vertex for which the confirmation confidence needs to be calculated. At high throughput, with e.g. several thousand or even several hundred thousand new vertices/transactions being added to the DAG each second, a substantial and soon physically intractable impossible number of numerical operations would thus need to be performed only to maintain reasonable estimates of the confirmation confidences for the vertices of the DAG. As mentioned above, in e.g. IOTA/Tangle, this situation is not maintainable, and coordinators are instead introduced as ultimate arbitrators in order to (completely) avoid having to use the MCMC algorithm as part of confirmation confidence calculations. Instead of each having to perform such calculations, the participating computing nodes instead await what the coordinator will say, which diminishes the decentralization and serves to introduce single-point-of-failures not desirable in decentralized ledgers.

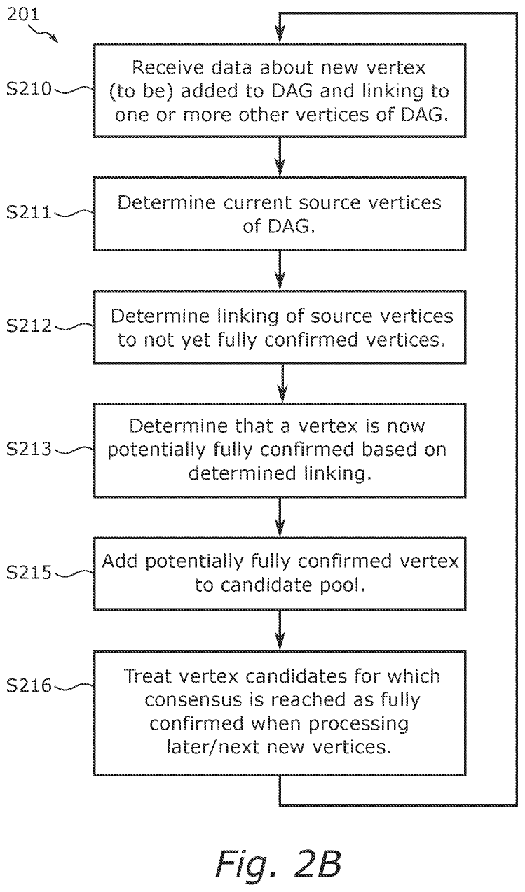

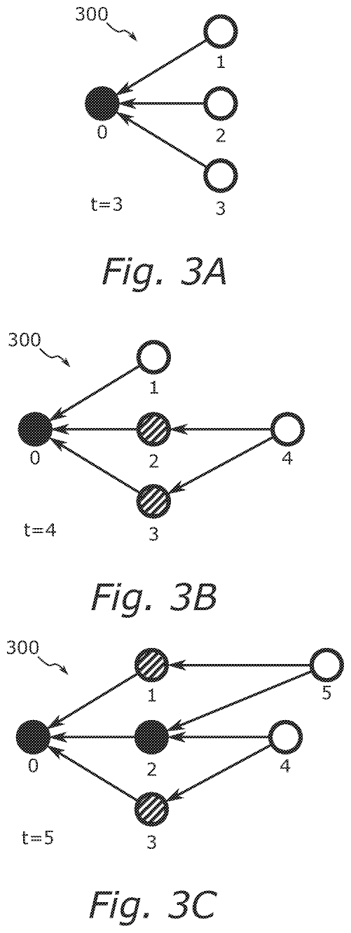

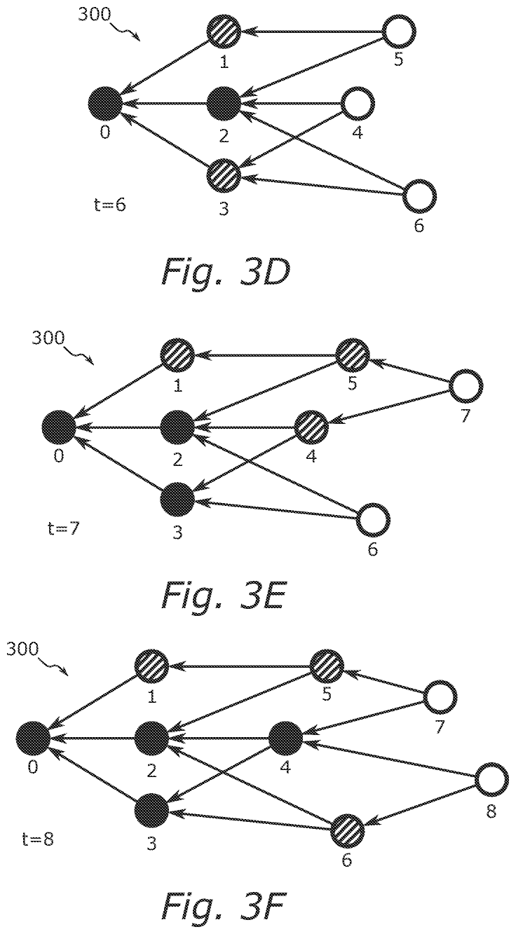

How the present disclosure proposes to overcome the above-discussed issues with contemporary technology will now be discussed in more detail with reference also to FIGS. 2A, 2B and 3A-3F.

FIGS. 2A and 2B are flowcharts of various exemplary methods for how to process new vertices of a DAG-based distributed ledger using a computer node, as envisaged herein. The envisaged methods may include calculation of confirmation ratios and/or to establish which vertices that are fully confirmed or not. FIGS. 3A-3F show an exemplary progression of how a DAG is formed by repeatedly adding new vertices, and will serve to illustrate one exemplary implementation of the proposed method in more detail.

With reference to FIG. 3A, a method 200 includes an operation S210 wherein data is obtained. The data is indicative of a new vertex that is added or to be added to the DAG, and the new vertex links to one or more other vertices of the DAG. The new vertex is a source vertex, i.e. it has zero indegree and finite outdegree. As an example, the data may indicate a new vertex set V_{new}, including information sufficient to identify the new vertex. For example, if the new vertex is assigned a unique index i, the new vertex set V_{new} may for example include such an index, e.g. V_{new}={i}. The data may also indicate a new vertex linking set V_{newLinks} including information sufficient to identify the one or more other vertices of the DAG to which the new vertex links. As an example, if the one or more other vertices have unique indices j and k, respectively, the new vertex linking set V_{newLinks} may include such indices, e.g. V_{newLinks}={j, k}.

The method 200 further includes an operation S211 wherein the current source vertices if the DAG (after adding the new vertex) are determined. This may include the use of data indicative of the current source vertices of the DAG. This data may for example, as part of operation S212, be updated by adding thereto at least an indication of the new vertex, and by removing therefrom any vertices which are linked to from the new vertex and which are thus no longer source vertices. For example, the data may indicate/include a source vertices set V_{sources} including information sufficient to identify all current source vertices of the DAG. In response to receiving (data about) the new vertex, maintaining the data up-to-date may include updating the source vertices set V_{sources} such that V_{new}∪(V_{sources} \V_{newLinks})→V_{sources}. Phrased differently, the up-to-date source vertices set V_{sources} may be defined as the union of the new vertex set V_{new} with the set difference between the previous source vertices set V_{sources} and the new vertex linking set V_{newLinks}.

The method 200 further includes an operation S212 in which a linking of the determined source vertices to not yet fully confirmed vertices of the DAG is established. This may e.g. include using a collection of not yet fully confirmed vertices represented e.g. as a unconfirmed vertices set C including indices of all vertices that are not yet determined as being fully confirmed, i.e. all vertices which are neither directly nor indirectly linked to from all current source vertices. For example, if the current yet to be fully confirmed vertices have respective indices i₁, i₂, . . . , the set C may include such indices such that C={i₁, i₂, . . . }. Data indicative of which current source vertices of the DAG that directly or indirectly links to (i.e. confirms) each of the vertices in the collection may be used. The data for each such particular vertex may for example, as part of operation S212, be updated by adding thereto the new vertex if the new vertex links to a vertex which has previously been identified as a source vertex directly or indirectly linking to the particular vertex, and by removing therefrom any such previously identified source vertex directly or indirectly linking to the particular vertex. For example, such data may for each particular i:th vertex indicate/include an unconfirmed vertex-specific linking set V_{sources,i} including information sufficient to identify all source vertices that directly or indirectly confirms (by linking to) the i:th vertex. For example, if the source vertices which directly or indirectly links to the i:th vertex have respective indices l₁, l₂, . . . , the unconfirmed vertex-specific linking set V_{sources,i} may include such indices, e.g. V_{sources,i}={l₁, l₂, . . . }. Maintaining the data up-to-date may for example include checking whether there is any overlap between the set V_{sources,i} of a particular yet to be fully confirmed i:th vertex and the new vertex linking set V_{newLinks} (i.e. whether the new vertex indirectly links to a current source vertex of the particular vertex), and to check whether the new vertex directly links to the particular vertex. As set operations, for indirect linking, this may include to check whether V_{sources,i} n V_{newLinks} #Ø, where n is the intersection operator and Ø denotes an empty set. If affirmative, the set V_{sources,i} may be updated by taking the union of the set V_{new} with the set difference between the set V_{sources,i} and the set V_{newLinks}, i.e. V_{new}∪(V_{sources,i}\V_{newLinks})→V_{sources,i}. To check whether the new vertex directly links to the particular vertex, this may include to check whether V_{newLinks}∩{i}+Ø (i.e., whether i∈V_{newLinks}) and, if affirmative, update the corresponding unconfirmed vertex-specific linking set V_{sources,i} as V_{sources,i}∪V_{new}→V_{sources,i}. If there is no overlap between the earlier set V_{sources,i} and the set V_{newLinks} and no overlap between V_{newLinks} and {i}, the operation S212 may include leaving the set V_{sources,i} unchanged. Phrased differently, maintaining the data concerning the linking up-to-date may include the operation ∇j∈C: [if V_{newLinks}∩(V_{sources,j}∪{j})+Ø:V_{new}∪(V_{sources,j}\V_{newLinks})→V_{sources,j}], or similar, taking into account that the new vertex may both directly and indirectly link to the particular vertex.

The method 200 further includes an operation S213 in which it is determined that at least one vertex has now become fully confirmed, i.e. directly or indirectly linked to from all current source vertices. This may e.g. be determined based on the confirmation ratio, and e.g. be based on the source vertices set V_{sources} and corresponding unconfirmed vertex-specific linking set(s) V_{sources,i}· As described earlier herein, within the realm of the present disclosure, the confirmation ratio δᵢ for an i:th vertex may be defined as a proportion of the number of current source vertices directly or indirectly linking to the i:th vertex to the total number of current source vertices. For example, the confirmation ratio δᵢ for the i:th vertex may be defined as a cardinality (i.e., the total number of elements) of the corresponding unconfirmed vertex-specific linking set V_{sources,i} divided by a cardinality of the source vertices set V_{sources}, e.g. as δᵢ=|V_{sources,i}|/|V_{sources}|. The confirmation ratios δᵢ may e.g. be stored in a set D={δᵢ_{₁}, δᵢ_{₂}, . . . }, where i₁, i₂, . . . ∈C. Alternatively, the confirmation ratio δᵢ may be determined as a ratio of a cardinality of an intersection between the sets V_{sources,i} and V_{sources}, to a cardinality of just the set V_{sources}, e.g. δᵢ=|V_{sources,i}∩V_{sources}|/|V_{sources}|.

The method 200 further includes an operation S214 in which one or more vertices now determined as being fully confirmed are treated as fully confirmed when (later) processing one or more next new vertices. The operation S214 may for example include determining that at least one vertex indicated in/by the collection set C is now fully confirmed, and to then exclude this at least one vertex from the collection set C. For example, if operation S213 includes determining that a set F of vertices (or indices of such vertices) are now fully confirmed, operation S214 may include updating the collection set C by removing any indication of the vertices of the set F therefrom. For example, the set C may be updated as C\F→C. Operation S214 may include determining that the addition of the new vertex did: i) not cause any vertex to become fully confirmed, ii) cause one vertex to become fully confirmed, or iii) cause more than one vertex to become fully confirmed, and update the collection set C accordingly.

After having e.g. calculated confirmation ratios for the various vertices as part of e.g. operation S213, and after having excluded any vertices that became fully confirmed as a result of adding the new vertex (if any), the method 200 may loop back to operation S210, in order to receive yet another new vertex added to the DAG, and process this next new vertex by repeating operations S211-S214 accordingly. Phrased differently, the method 100 is configured to repeatedly obtain data about new vertices added or to be added to the DAG, and to, for e.g. each such new vertex, perform operations S211 through S214.

With reference to FIG. 2B, another exemplary method 201 includes the same operations S210-S213 that the method 200 described with reference to FIG. 2A. However, in the method 201, the computing node implementing the method 201 does not, after confirming that it has found at least one vertex which it now considers to be fully confirmed as a result of adding the new vertex, immediately decide to e.g. remove such a vertex from the collection of not yet fully confirmed vertices. Instead, after operation S213, the method 201 includes another operation S215 wherein the particular vertex is instead considered as a candidate fully confirmed vertex (e.g. a potentially fully confirmed vertex), and is added to a pool of fully confirmed vertex candidates that are shared between multiple computing nodes all taking part in implementing the ledger in a distributed way. Each such computing node is, as envisaged herein, configured to access such a shared pool of candidate vertices, and the computing nodes are envisaged as being configured to, using some suitable methodology, reach consensus about which vertices in the shared pool should be treated as being actually fully confirmed by all computing nodes. Thus, in the method 201, there may be a delay between a particular computing node determining that a particular vertex is fully confirmed, and a sufficient number of other computing nodes also arriving at a same conclusion. Consequently, after having added a particular vertex to the pool of candidate vertices, the method 201 may proceed by leaving the candidate vertex as part of the collection C of vertices that are yet to be fully confirmed, until consensus is reached among the participating computing nodes that this candidate vertex should be treated as fully confirmed. Thus, the method 201 includes another operation S216 in which all candidate vertices for which consensus has been reached are actually removed/excluded from the collection C (i.e., treated as now being fully confirmed). Phrased differently, until consensus is reached for a particular candidate vertex, the method 201 may proceed from operation S215 back to operation S210. Once consensus is reached for at least one candidate vertex, the method may first proceed from operation S215 to operation S216, and then back to operation S210.

In common to both methods 200 and 201 is that they have the major advantage that they more efficiently allow to process new vertices added to the graph, and in particular allow to process new vertices arriving at a high rate without exceeding computational power and/or storage limitations. The methods 200 and 201 may for example more quickly determine confirmation ratios of vertices of the DAG, without having to rely on computationally expensive algorithms such as MCMC or similar. In addition, the determined confirmation ratios δᵢ are not probabilistic, but represent the actual, true confirmation ratios of the respective vertices. It can therefore be ascertained that once a particular vertex becomes fully confirmed by all current source vertices, the particular vertex can be considered forever fully confirmed and does not need to be considered as part of evaluating the confirmation ratios for other nodes as part of further new vertices being added to the DAG. It has been realized by the inventor that as the DAG evolves, the number of vertices that are source vertices will be fairly consistent as new vertices are added to the DAG, which also applies to the number of vertices that become fully confirmed at each time step. Consequently, the size of e.g. the data indicating the number of current source vertices (such as the source vertices set V_{sources}) as well as the size of the collection of vertices that are yet to be fully confirmed (e.g. C) will remain approximately the same and not e.g. grow towards infinity. The size of the data used to represent the linking between source vertices and not yet fully confirmed vertices, including e.g. unconfirmed vertex-specific linking set(s) (V_{sources,i}), is also expected to remain roughly the same at any time instance, as the DAG reaches an equilibrium wherein a rate of new vertices added to the DAG is approximately the same as a rate at which previously added vertices become fully confirmed. The computational complexity of finding the confirmation ratios for yet to be fully confirmed vertices will thus remain manageable throughout the evolution of the DAG, and allow for larger DAGs to be used and in particular for higher rates at which new transactions/vertices are added to the DAG. This while the computational load on each computing node taking part in forming the distributed ledger is expected to remain approximately the same, and not increase with prolonged system operation. This because, for each particular vertex for which e.g. the confirmation ratio is to be determined, the envisaged method does not require to traverse all the way from the genesis vertex, to the particular vertex and on to a source vertex (as in the MCMC algorithm). Instead, after adding a new vertex to the DAG, only a few elements in the corresponding data/sets are required to be updated, and the envisaged method may therefore operate more quickly, with less and more plannable computational effort and with less memory requirement.

For example, it was earlier herein indicated that the MCMC requires [symbol] (MkNₜₒₜ) operations to recalculate/estimate a confirmation ratio (or confidence) for a single vertex, for chains of average length M, with k average links to each previous vertex on the way to new vertices, and wherein the algorithm is run Nₜₒₜ times. For the envisaged improved method(s), only [symbol] (k) operations are, on average, required to update a confirmation ratio for a particular vertex as a new vertex is added to the DAG, as part of maintaining e.g. the data for the current source vertices (including e.g. source vertices set V_{sources}) and data for the linking (including e.g. unconfirmed vertex-specific linking set(s) V_{sources,i}) up-to-date. The improved method(s) as envisaged herein therefore provides a substantial speed-up (on the order of [symbol] (MNₜₒₜ)) vis-à-vis conventional technology based on e.g. MCMC or similar, and this without taking into account that such conventional technology also need to spend considerable amount of time/operations on recalculating cumulative weights. For example, without taking recalculation of cumulative weights into account, for a DAG with M=1000 and an MCMC algorithm repeated Nₜₒₜ=100 times, the improved method(s) as envisaged herein will reduce the number of required operations/calculations with a factor of approximately one hundred thousand. If taking recalculation of cumulative weights into account, which may e.g. be considered as requiring at least ten times as many operations than e.g. updating indices in V_{sources} and V_{sources,i}, the enabled reduction of operations/calculations as provided by the envisaged method(s) may approach one million.

For completeness, it should be mentioned that one known way of improving the performance of the MCMC algorithm includes the use of a so-called throwing depth W, wherein the paths generated as part of the tip selection algorithm is not necessarily started from the genesis vertex but instead from some later vertex of the graph. For example, the throwing depth may be defined as a distance W from the most recent vertex of the DAG to the vertex at which the MCMC-path is started . . . In this case, N will be bound to W and not grow indefinitely with time, resulting in the modified MCMC algorithm having fixed complexity. However, limiting the throwing depth W may reduce the utility of the MCMC algorithm against e.g. lazy nodes, and may render the algorithm meaningless for e.g. small values of W. In addition, for using the MCMC algorithm to calculate/estimate confirmation confidence, the throwing depth W should preferably be no less than the depth of the particular vertex, meaning that the value of W cannot a priori be small. In contrast, in the improved method(s) as proposed herein, the complexity is low and does not increase with time.

It is envisaged herein that a throwing depth W may also be incorporated in the proposed method(s). For example, updating the data for the linking (including e.g. unconfirmed vertex-specific linking set(s) V_{sources,i}) may be performed only if the throwing depth W is deeper than, or equal to, the depth of the particular vertex for which the confirmation ratio is to be determined. For example, if vertices of the DAG are numbered sequentially in increasing order as they are added to the DAG, a condition for updating the linking data for the i:th vertex may be defined as W≥Nₗₐₜₑₛₜ−i, where Nₗₐₜₑₛₜ is the integer given to the most recent vertex of the DAG. As an alternative, the throwing depth W may instead be defined as the integer index given to the vertex at which the MCMC-path should start, in which case the condition for when to update the linking data for the i:th vertex is just W≤i. In addition, updating the linking data may also be performed if the throwing depth W is shallower than the depth of the particular vertex, as long as the particular vertex is still not fully confirmed, i.e. when δᵢ<1.0 and W<Nₗₐₜₑₛₜ−i (or W>i if using the latter definition of W).

With reference to FIGS. 3A-3F, an example of a possible progression of the method 200 (or 201) will now be illustrated in more detail.

With reference to FIG. 3A, an example DAG 300 is shown at a snapshot at an example time t=3. At this stage, a genesis vertex o has already been added, and there are currently three vertices 1, 2 and 3 linking to the genesis vertex o. At this stage, the data about the source vertices may e.g. indicate/include a source vertices set V_{sources}={1,2,3}, as vertices 1,2,3 are all source vertices of the DAG 200 as indicated by the empty circles. The genesis vertex o is fully confirmed, but will not be taken into account in this example by way of design, the collection of vertices that are yet to be fully confirmed is defined as C={1,2,3}. As none of the source vertices 1, 2 and 3 (by definition) have finite indegree, the linking data for each vertex 1, 2, 3 is or includes e.g. an empty unconfirmed vertex-specific linking set, i.e. V_{sources,1}=V_{sources,2}=V_{sources,3}=Ø. Likewise, the confirmation rates are determined to be zero, i.e. δ₁=δ₂=δ₃=0.

With reference to FIG. 3B, at a next time t=4, a fourth vertex 4 has been added to the DAG 300, linking to/confirming the vertices 2 and 3. Which vertices the vertex 4 links to may e.g. have been decided by throwing a dice, based on probabilities set according to cumulative weights of the vertices 1, 2,3, or based on some other selection algorithm for deciding to which previous vertices a new vertex should link. As a resulting of adding the vertex 4, vertices 2 and 3 are no longer source vertices, at least as seen from the particular computing node implementing the method. Thus, there may be some delay until all computing nodes have a same picture of the state of the DAG 300, and some computing nodes may e.g. still continue to refer to vertex 2 and/or 3 as source vertices until the information about the newly added vertex 4 reaches also these nodes. In any way, for the particular computing node in question which has a local copy of the DAG 300 as illustrated in FIG. 3B, the data about the new vertex indicates/includes e.g. the new vertex set V_{new}={4} and new vertex linking set V_{newLinks}={2,3}, and the data about the source vertices is updated such that {4}∪({1,2,3}\{2,3})→V_{sources}, i.e. V_{sources}={1,4}. The collection of yet to be confirmed vertices is updated by adding thereto the new vertex 4, i.e. C={1,2,3,4}. The linking data for the vertex 4 indicates an empty unconfirmed vertex-specific linking set, i.e. V_{sources,4}=Ø, while the linking data for the vertices 2 and 3 (which are no longer source vertices as indicated by the dashed filling of their respective circles) is updated such that e.g. V_{sources,2}={4} and V_{sources,3}={4} (as vertex 4 links directly to each of vertices 2 and 3). The linking data for the vertex 1 still indicates an empty set, e.g. V_{sources,1}=Ø, as vertex 1 remains a source vertex. The confirmation ratios for vertices 1 and 4 are zero, i.e. δ₁=δ₄=0, while the confirmation ratios for the vertices 2 and 3 may be determined to be

$${δ}_{2} = \frac{\vert {V}_{sources , 2} \vert}{\vert {V}_{sources} \vert} = \frac{\vert \{ 4 \} \vert}{\vert \{ 1 , 4 \} \vert} = \frac{1}{2} = 0.5$$

$$and$$

$${δ}_{3} = \frac{\vert {V}_{sources , 3} \vert}{\vert {V}_{sources} \vert} = \frac{\vert \{ 4 \} \vert}{\vert \{ 1 , 4 \} \vert} = \frac{1}{2} = 0.5 .$$

With reference to FIG. 3C, at a next time t=5, a new vertex 5 is added to the DAG 300, linking to vertices 1 and 2. Following the same procedure as outlined above, it is established that V_{new}={5} and V_{newLinks}={1,2}, and that V_{sources}={5} U ({1,4}\{1,2})={4,5}, such that vertex 1 is no longer a source vertex, and that C={1,2,3,4,5}. Likewise, it is determined that V_{sources,1}={5}, V_{sources,2}={4,5}, V_{sources,3}={4} and V_{sources,4}=V_{sources,5}=Ø. The confirmation ratios are consequently determined as δ₁=0.5, δ₂=1.0, δ₃=0.5 and 84=85=0. It is confirmed that vertex 2, for which 82=1.0, is now, as a resulting of adding vertex 5, a fully confirmed vertex (as indicated by the filled circle), and the vertex 5 is consequently excluded from the collection of yet to be fully confirmed vertices such that C={1,2,3,4,5}\{2}={1,3,4,5}. If following proposed method 201, the set C may be kept intact, and vertex 2 may instead be reported as a candidate vertex by adding (an indication of) vertex 2 to a shared pool of fully confirmed vertex candidates, and the vertex 2 may be removed from the collection C and treated as a fully confirmed vertex only after consensus is obtained among the participating computing nodes that such is the case.

With reference to FIG. 3D, at a next time t=6, a new vertex 6 is added to the DAG 300, linking to vertices 2 and 3. Consequently, it is established that V_{new}={6} and V_{newLinks}={2,3}, that V_{sources}={6}∪({4,5}\{2,3})={4,5,6}, and that C={1,3,4,5,6}. Likewise, the linking data instances are updated such that V_{sources,1}={5}, V_{sources,3}={4,6} and V_{sources,4}=V_{sources,5}=V_{sources,6}=Ø. The confirmation ratios are updated/recalculated as δ₁=1/3, δ₃=2/3 and δ₄=δ₅=δ₆=0. It should be noted that as vertex 2 was excluded from the collection C during the previous time instance, linking data is no longer necessarily maintained for vertex 2 as it is no longer required to consider vertex 2 when calculating further confirmation ratios for other vertices. Also, as there are no new vertices becoming fully confirmed as a result of adding vertex 6, no vertices are excluded from the collection C in response to the updated confirmation ratios.

With reference to FIG. 3E, at a next time t=7, a new vertex 7 is added to the DAG 300, linking to vertices 4 and 5. Consequently, it is established that V_{new}={7} and V_{newLinks}={4,5}, that V_{sources}={7}∪({4,5,6}\{4,5})={6,7}, and that C={1,3,4,5,6,7}. As the new vertex 7 links to vertex 4 which was previously a source vertex linking (directly) to vertices 2 and 3, and to vertex 5 which was previously a source vertex linking (directly) to vertices 1 and 2, there is an overlap between previous V_{sources,i} (where i∈{1,3}) and V_{newLinks}. Thus, the linking data for these vertices 1 and 3 are updated accordingly as V_{new}∪(V_{sources,i}\V_{newLinks})→V_{sources,i}, i.e. such that V_{sources,1}={7}∪({5}\{4,5})={7} and V_{sources,3}={7}∪({4,6}\{4,5})={6,7}. For the remaining vertices in C, it is established that V_{sources,4}=V_{sources,5}={7} and V_{sources,6}=V_{sources,7}=Ø. The confirmation ratios are determined/updated as δ₁=0.5, δ₃=1.0, δ₄=δ₅=0.5 and δ₆=δ₇=0. As δ₃=1.0, vertex 3 is now considered a fully confirmed vertex, and is excluded from the collection C such that C={1,4,5,6,7} (and/or e.g. added to the pool of candidate vertices until consensus is reached among the participating computing nodes to treat vertex 3 as fully confirmed). In this particular iteration of the method 200 (or 201), it should be noted that adding a vertex which links to one or more previous source vertices, only minor updates of the corresponding linking data (e.g. V_{sources,i}) for vertices to which these previous source vertices directly or indirectly linked to is necessary, adding to the improved performance of the proposed method(s) vis-à-vis contemporary solutions.

With reference to FIG. 3F, at a next time t=8, a new vertex 8 is added to the DAG 300, linking to vertices 4 and 6. It is thus established that V_{new}={8} and V_{newLinks}={4,6}, that V_{sources}={8}∪({6,7}\{4,6})={7,8}, and that C={1,4,5,6,7,8}. The new vertex 8 links to vertices 4 and 6 that were previously source vertices directly (or indirectly) linking to vertex 2 and 3, but as vertices 2 and 3 has since been excluded from the collection C, this requires no further action. The linking data is updated only for V_{sources,4}={7,8} and V_{sources,6}={8}, as those are the only vertices remaining in the collection C and for which the new vertex 8 changes the configuration of source vertices linked from. The confirmation ratios are updated/recalculated according to δ₁=0.5, δ₄=1.0, δ₅=0.5, δ₆=0.5 and δ₇=δ₈=0. As δ₄=1 indicates that vertex 4 has now become fully confirmation as a result of adding vertex 8, vertex 4 is removed/excluded from the collection C such that C={1,5,6,7,8}. The method 200 (or 201) may then repeat in a similar manner for each new vertex added to the DAG 300.

If e.g. performing method 201, it may in some situations e.g. be so that consensus about for example vertex 3 being fully confirmed is reached no earlier than at time t=8. In such a situation, vertex 3 will thus remain in the collection C at times t=7 and beginning of t=8, and only be excluded and treated as fully confirmed at the end of time t=8, and similar. This does however not change the performance of the proposed method substantially, as there is only expected to be some finite delay before consensus is reached for a particular vertex once it is added for the first time to the pool of fully confirmed vertex candidates. It should be noted that the computing node may also experience delay in receiving information about a new vertex/transaction being added to the DAG, which may compensate (in terms of computational complexity) of having to keep track of a proposed candidate vertex for a bit longer.

In summary so far, it should be noted that as soon as a vertex is determined to be and treated as being fully confirmed, or at least as soon as consensus is reached for such a decision among the plurality of computing nodes taking part in implementing the distributed ledger, the vertex may be included in an irrevocable part of the ledger and not given any further consideration when e.g. determining confirmation ratios for other vertices or when generally processing other, new vertices. This because as soon as a vertex has been confirmed by all current source vertices, it will indirectly be confirmed also by all other new vertices added to the DAG and referencing previous source vertices of the DAG.

Envisaged herein is also yet-another alternative way of processing new vertices, wherein instead of defining and updating linking data for each not yet fully confirmed vertex (e.g. V_{sources,i}), the method instead includes defining and updating linking data for each current source vertex, indicating which not yet fully confirmed vertices that each current source vertex directly or indirectly links to. This alternative way will, in the end, render the same results in terms of e.g. confirmation ratios and similar, and will now be described in more detail with reference once again to FIGS. 3A to 3F.

As for the previous described way of processing new vertices, the alternative way starts out as in FIG. 3A by establishing that at time instance t=3, vertex o is a genesis vertex, the source vertices 1, 2, 3 may be indicated in a source vertices set V_{sources}={1,2,3}, and the vertices 1, 2, 3 are all yet to be fully confirmed and thereby part of the collection C={1,2,3}. The alternative way includes to define, as part of determining the linking of the source vertices to the not yet fully confirmed vertices linking data for each source vertex, such as data indicating/including (for an i:th vertex) a source vertex-specific linking set Cᵢ. In the situation shown in FIG. 3A, there are no yet to be fully confirmed vertices (except the genesis vertex o, that does not count), and consequently it is established that C₁=C₂=C₃=Ø. Confirmation ratios for the current vertices of the DAG 300 may also be established as δ₁=δ₂=δ₃=0. In the alternative way, which vertices of the DAG 300 that are fully confirmed may be found as the result of the operation C₁∩C₂∩C₃, which in this situation results in an empty set Ø as there are no fully confirmed nodes. In general, a set of fully confirmed nodes may, in the alternative way of processing new vertices, be found by an intersection of all source vertex-specific linking sets for all current source vertices.

At the time instance t=4 as shown in FIG. 3B, the new vertex 4 links to vertices 2 and 3 and establishes that V_{new}={4} and V_{newLinks}={2,3}. The source vertices after adding the new vertex 4 is found as in the former way described earlier herein, i.e. V_{new} U (V_{sources} \V_{newLinks})→V_{sources}, such that V_{sources}={4} U ({1,2,3} {2,3})={1,4}. The collection of not yet fully confirmed vertices is extended by adding thereto V_{new}, i.e. C={1,2,3} u {4}={1,2,3,4}. To determine the linking, the former C; for the previous source nodes does not change, but only a new source vertex-specific linking set is added for the new vertex 4, i.e. C₄. This set is found by a union of V_{newLinks} with a union of the source vertex-specific linking sets for all vertices to which the new vertex 4 links, i.e. in this case C₄=V_{newLinks}∪C₂∪C₃, as V_{newLinks} indicates that the new vertex 4 links to vertices 2 and 3. If defining an operator [{Xⱼ}∪]_{B} (where B={b₁, b₂, b₃, . . . , b_{N}} and Xⱼ unspecified sets) to mean X_{b}_{₁}∪X_{b}_{₂}∪X_{b}_{₃}∪ . . . ∪ X_{b}_{_{N}}, the new source vertex-specific linking set for a new j:th vertex is thus generally found as Cⱼ=V_{newLinks}∪[{Cₖ}∪]v_{newlinks}. In this particular case, it is established that C₄={2,3}∪Ø∪Ø={2,3}. Likewise, if defining an operator [{Xⱼ}∩]_{B} to mean X₁∩X₂∩X₃∩ . . . ∩ X_{N}, the set of fully confirmed vertices are found as [{Cⱼ}∩]ᵥ_{_{sources}}.

In the alternative way, a confirmation ratio for a particular vertex may be found by examining in how large a proportion of the source vertex-specific linking sets for the current source vertices the particular vertex is indicated. At time instance T=4, the source vertices are 1 and 4, and C₁=Ø and C₄={2,3}. Thus, the confirmation ratios for vertices 1 and 4 are zero, and the confirmation ratios for vertices 2 and 3 is 0.5 (50%) as both indices 2 and 3 are found once in the two sets C₁ and C₄. The set of fully confirmed vertices is established as C₁∩C₄=Ø.

At time instance t=5 as shown in FIG. 3C, it may similarly be established that V_{new}={5}, V_{newLinks}={1,2}, C={1,2,3,4,5}, and the source vertex-specific linking set for the new vertex 5 is C₅=V_{newLinks}∪[{Xⱼ}∪]_{V}_{_{newLinks}}, i.e. that C₅={1,2}∪C₁∪C₂={1,2}∪Ø∪Ø={1,2}. The confirmation ratios are found by studying how many times each vertex index is appears in C₄ and C₅ (as vertices 4 and 5 are the current source vertices), i.e. δ₁=0.5 (the index “1” appears in C₅={1,2} but not in C₄={2,3}), δ₂=1.0 (the index “2” appears in both C₄ and C₅), δ₃=0.5, δ₄=0 and δ₅=0. Vertex 2 is thus determined as being fully confirmed, which is also revealed by the set C₄∩C₅={2,3}∩{1,2}={2}.

At time instance t=6 as shown in FIG. 3D, it may similarly be established that V_{new}={6}, V_{newLinks}={2,3}, V_{sources}={4,5,6}, C={1,3,4,5,6} (as vertex 2 is now treated as being fully confirmed), C₆={2,3}, δ₁=1/3 (the proportion of C₄, C₅ and C₆ in which index “1” appears, etc.), δ₃=2/3, δ₄=0, δ₅=0, δ₆=0, and that C₄∩C₅∩C₆={2,3}∩{1,2}∩{2,3}={2}, i.e. vertex 2 remains the only fully confirmed vertex.

At time instance t=7 as shown in FIG. 3E, it may similarly be established that V_{new}={7}, V_{newLinks}={4,5}, V_{sources}={6,7}, C={1,3,4,5,6,7}, C₇={1,2,3,4,5}, δ₁=1/2 (the proportion of C₆ and C₇ in which index “1” appears, etc.), δ₃=1, δ₄=1/2, δ₅=1/2, δ₆=0, δ₇=0 and that C₆∩C₇={2,3}∩{1,2,3,4,5}={2,3}, i.e. also vertex 3 is now fully confirmed.

At time instance t=8 as shown in FIG. 3F, it may similarly be established that V_{new}={8}, V_{newLinks}={4,6}, V_{sources}={7,8}, C={1,4,5,6,7,8}, C₈={2,3,4,6}, δ₁=1/2 (the proportion of C₇ and Cg in which index “1” appears, etc.), δ₄=1, δ₅=1/2, δ₆=1/2, δ₇=0, δ₈=0 and that C₂∩C₈={1,2,3,4,5}∩{2,3,4,6}={2,3,4}, i.e. also vertex 4 is now fully confirmed.

When comparing the alternative way of processing new vertices with the previously described way, it is obvious that the results obtained are the same. However, the previously described way (using the unconfirmed vertex-specific linking sets as linking data) may e.g. be more particularly suitable to calculate confirmation ratios, as only a division operation is needed. The alternative way (using the source vertex-specific linking sets as linking data) may e.g. be more particularly suitable to find a set of (all) fully confirmed vertices, by performing intersection operations on the various sets Cⱼ, and especially provide faster results in situations where only finding vertices with unit confirmation ratio is important. It may also be noted that the two ways also consumes approximately the same low amount of memory. In the first (previously described) way, it is usually required to store |C| different sets V_{sources,i} (one for each not yet fully confirmed vertex), each including |V_{sources}| elements (one for each source vertex). In the second (alternative) way, it is usually required to store fewer sets, i.e. |V_{sources}| sets (one for each source vertex), but wherein a number of elements in each such set equals |C| (one for each not yet fully confirmed vertex). Thus, on average, the memory requirements for each way is of the same order [symbol] (|C||V_{sources}|).

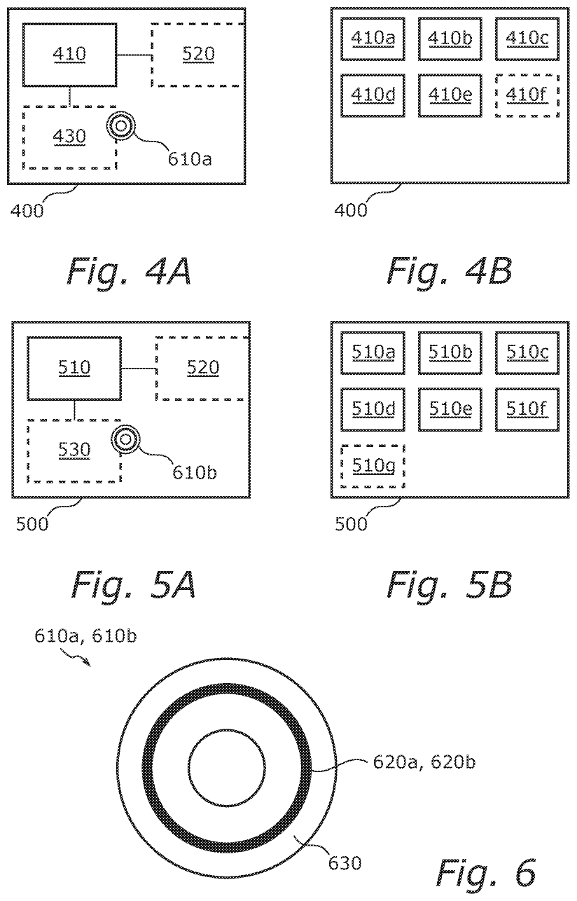

Various entities and computer programs/computer program products as envisaged herein will now be described in more detail with reference also to FIGS. 4A, 4B, 5A, 5B and 6.

FIGS. 4A, 4B, 5A and 5B schematically illustrate, in terms of a number of functional units, the components of exemplary computing node entities 400 and 500 for processing new vertices of a DAG-based distributed ledger as envisaged herein. The computing node entity 400 is configured for performing the method 200 described herein with reference to FIG. 2A, while the computing node entity 500 is configured for performing the alternative method 201 described with reference to FIG. 2B. The computing node entities 400 and 500 includes respective processing circuitry 410 and 510. The processing circuitry 410, 510 is provided using any combination of one or more of a suitable central processing unit (CPU), multiprocessor, microcontroller, digital signal processor (DSP), etc., capable of executing software instructions stored in a respective computer program product 610a, 610b (see FIG. 6 and the description thereof), e.g. in form of a respective storage medium 430, 530 that may also form part of the respective computing node entity 400, 500. The respective processing circuitry 410, 510 may further be provided as at least one application specific integrated circuit (ASIC), or field-programmable gate array (FPGA).

Particularly, the processing circuitry 410, 510 is configured to cause the respective computing node entity 400, 500 to perform a set of operations, or steps, as disclosed above e.g. when describing the respective methods 200 and 201 illustrated in FIGS. 2A and 2B. For example, the respective storage medium 430, 530 may store a set of operations, and the respective processing circuitry 410, 510 may be configured to retrieve the set of operations from the storage medium 430, 530 to cause the computing node entity 400, 500 to perform the set of operations. The set of operations may be provided as a set of executable instructions. Thus, the respective processing circuitry 410, 510 is thereby arranged to execute methods associated with methods 200, 201 as disclosed herein e.g. with reference to FIGS. 2A and 2B.

The respective storage medium 430, 530 may also include persistent storage, which, for example, can be any single or combination of magnetic memory, optical memory, solid state memory or even remotely mounted memory.

The respective computing node entity 400, 500 may further include a respective communications interface 420, 520 for communications with other entities, functions, nodes, and devices, such as e.g. those of a (peer-to-peer) network of interconnected computing nodes taking part in implementing a DAG-based distributed ledger. For example, the communications interface 420, 520 may allow the respective computing node entity 400, 500 to communicate with e.g. other such computing node entities of the network, and/or e.g. with various other nodes connected to the network, such as nodes responsible only for receiving transactions from individuals or similar and forward these to the computing node entities responsible for adding, verifying and synchronizing such transactions as part of the DAG. For example, the communications interface 420, 520 may be configured to (repeatedly) receive one or more signals indicative of data for the/a new vertex as described herein, and to output (at least in case of the entity 520) one or more signals indicative of e.g. candidate vertices as also described herein, and similar. As such, the respective communication interface 420, 530 may include one or more transmitters and receivers, including analogue and/or digital components. For example, the communications interface 420, 520 may be used to obtain data about new transactions that are to be added to the DAG and distributed ledger, data about potential candidate vertices from a shared pool, synchronization data (such as e.g. gossip data) from other computing nodes, and e.g. also output such data to one or more of the other interconnected computing nodes of the network. The communications interface 420, 520 may of course also be capable to exchange (i.e. receive and/or transmit) data related to establishing of peer-to-peer connections within the network, time data, transaction data, control data, and similar data required to jointly with other computing node entities form the distributed ledger.

The processing circuitry 410, 510 controls the general operation of the respective computing node entity 400, 500 e.g. by sending data and control signals to the communications interface 420, 520 and the storage medium 430, 530, by receiving data and reports from the communications interface 420, 520, and by retrieving data and instructions from the storage medium 430, 530. Other components, as well as their related functionality, of the respective computing node entity 400, 500 are omitted in order not to obscure the concepts presented herein.

FIGS. 4B and 5B schematically illustrate, in terms of a number of functional modules 410a-410f and 510a-510g, the components of respective computing node entities 400, 500 according to exemplary embodiments of the present disclosure. The computing node entity 400 includes at least a first data receive module 410a configured to perform operation S210 of the method 200 described with reference to FIG. 2A. The computing node entity 400 also includes a source vertex determination module 410b configured to perform operation S211, a vertex linking determination module 410c configured to perform operation S212, a fully confirmed vertex determination module 410d configured to perform operation S213, and an exclude module 410e configured to perform operation S214. In other embodiments, some or all of modules 410a-410e may instead be provided as part of a single module. The computing node entity 400 may also include one or more optional functional modules (illustrated by the dashed box 410f), such as for example a module to take into account throwing depth as discussed herein, or similar.

Similarly, the computing node entity 500 includes at least a first data receive module 510a configured to perform operation S210 of the method 201 described with reference to FIG. 2B, a source vertex determination module configured to perform operation S211, a vertex linking determination module 510c configured to perform operation S212, and a fully confirmed vertex determination module 510d configured to perform operation S213. The computing node entity 500 further includes a pool adding module 510e configured to perform operation S215, and a consensus-exclusion module 510f configured to perform operation S216. Just as for the computing node entity 400, the computing node entity 500 may also include one or more optional, additional functionality modules (indicated by the dashed box 510g) for performing other tasks necessary to implement the DAG-based distributed ledger as part of a network of interconnected computing node entities, and similar, and it is envisaged of course that one or more or all of the modules 510a-510g may also be implemented as fewer modules or even as a single module.

In general terms, each functional module 410a-410f and 510a-510g may be implemented in hardware or in software. Preferably, one or more or all functional modules 610a-c may be implemented by the respective processing circuitry 410, 510, possibly in cooperation with the communications interface 420, 520 and/or the storage medium 430, 530. The respective processing circuitry 410, 510 may thus be arranged to from the storage medium 430, 530 fetch instructions as provided by a respective functional module 410a-410f, 510a-510g, and to execute these instructions and thereby perform any operations of the respective method 200, 201 performed by/in the respective computing node entity 400, 500 as disclosed herein.

FIG. 6 schematically illustrates a computer program product 610a, 610b including computer readable means 630. On the computer readable means 630, a computer program 620a can be stored, which computer program 620a can cause the processing circuitry 410 and thereto operatively coupled entities and devices, such as the communication interface 420 and the storage medium 430, of the computing node entity 400 to execute method 200 according to embodiments described herein with reference to FIG. 2A. The computer program 620a and/or computer program product 610a may thus provide means for performing any operations of the method 200 performed by the computing node entity 400 as disclosed herein.

On the computer readable means 630, a computer program 620b can also be stored, either in addition to or instead of the computer program 620a, which computer program 620b can cause the processing circuitry 510 and thereto operatively coupled entities and devices, such as the communication interface 520 and the storage medium 530, of the computing node entity 500 to perform the method 201 according to embodiments described herein with reference to FIG. 2B. The computer program 620b and/or computer program product 610b may thus provide means for performing any operations required to perform the method 201 performed by the computing node entity 500 as disclosed herein.

In the example of FIG. 6, the computer program product 610a, 610b and computer readable means 630 are illustrated as an optical disc, such as a CD (compact disc) or a DVD (digital versatile disc) or a Blu-Ray disc. The computer program product 610a, 610b and computer readable means 630 could also be embodied as a memory, such as a random-access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 620a, 620b are here schematically shown as a track on the depicted optical disk, the computer program 620a, 620b may be stored in any way which is suitable for the computer program product 610a, 610b and computer readable means 630.

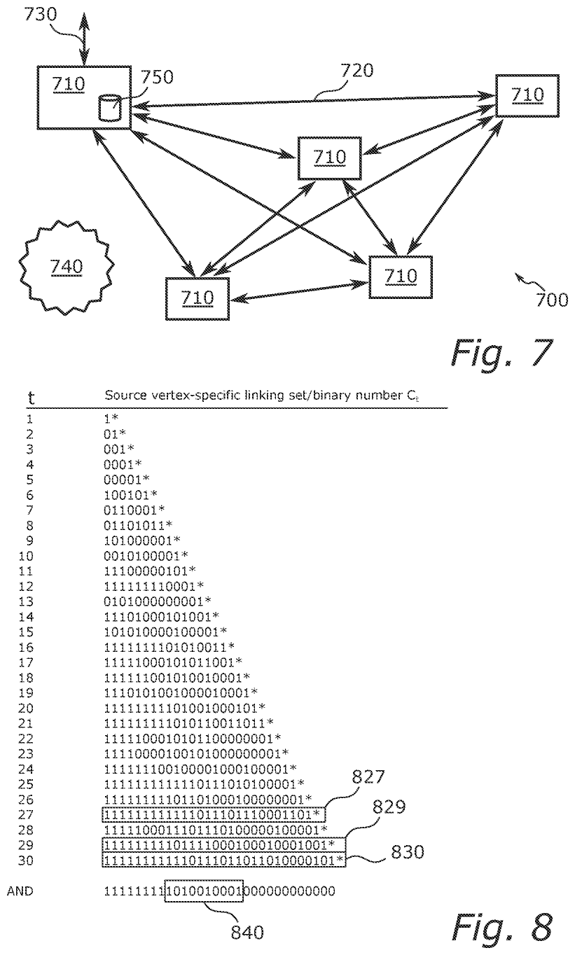

With reference to FIG. 7, an exemplary system/network of multiple computing node entities as envisaged herein will now be described in more detail. With reference also to FIG. 7, a network 700 includes a plurality of computing node entities 710, connected in a peer-to-peer (P2P) network fashion as indicated by the established communication channels 720 between the various computing node entities 710. Each, or at least some, of the computing node entities 710 may e.g. be computing node entities 400, 500 as described earlier herein with reference to FIGS. 4A, 4B, 5A and 5B, and be configured to e.g. perform the method 200 or 201 as described with reference to FIGS. 2A and 2B. Each, or at least one or some, of the computing node entities 710 may be configured to receive, either from one or more of the other computing node entities (via e.g. a gossip protocol) or from an additional communication channel 730 to e.g. an entity responsible for receiving requests for transactions from one or more individuals/parties, and to communicate such transaction requests to one or more of the computing node entities 710 in order to make such transactions added to the DAG, after being verified and agreed upon by the computing nodes 710 using suitable consensus mechanisms. In some examples of the system/network 700, the computing node entities 710 have access to a shared pool 740 of fully confirmed vertex/transaction candidates, to which pool 740 a computing node entity 710 may add a particular vertex/transaction once the computing node entity 710 determines that the vertex appears to be fully confirmed at least to a local version of the DAG 750 kept/maintained by the computing node entity 710. Using some suitable consensus mechanism, the computing node entities 710 may then together agree upon which of the candidate vertices in the pool 740 are to be considered fully confirmed by all computing node entities 710, and the respective computing node entities 710 may then take this info into account in their local DAG copies/versions 750 and when adding new transactions to the distributed ledger. For example, a computing node entity 710 may receive (e.g. via the communication channel 730) information about a transaction that is to be added to the distributed ledger. The computing node entity 710 may insert (after e.g. some initial verification of the transaction based on formality) the new transaction as part of a vertex that it added to its local DAG 750, and then proceed with calculating e.g. confirmation ratios as described herein as part of verifying the new transaction. Once verified at least by the computing node entity 710, the computing node entity 710 may e.g. gossip about the new transaction to other computing node entities 710, which may either accept the new transaction/vertex without questioning or perform their own verification procedure. As part of such processes, each computing node entity 710 may provide suggestions for new candidate vertices to the shared pool 740, and consensus may be reached among the computing node entities 710 which vertices that are really fully confirmed, and such vertices may then be added to an irrevocable part of the ledger and not taken into account for further calculations of e.g. confirmation ratios, with the benefits vis-à-vis conventional technology described herein.

As also envisaged herein, a realization of the inventor(s) is that sets of vertices may preferably be stored as binary numbers, wherein each bit of such a binary number is associated with a particular vertex. For example, each vertex of the DAG may be assigned a (unique) integer ID, i.e. an integer number. For example, the integer associated with the genesis vertex may be zero, and each other vertex may be assigned an increasing integer, such as 1, 2, 3, . . . , up to the current number of vertices in the DAG. A binary number may be considered as being numbered from left to right, i.e. with the least significant bit placed leftmost and the most significant bit placed rightmost. Each bit in the binary number may be associated with a particular vertex, e.g. such that the first bit is associated with the vertex having integer “1”, the second bit is associated with the vertex having integer “2”, and so on until all vertices that are required to be represented by the binary number are included. For example, in a DAG having a total of eight vertices, a binary number having eight bits may represent all possible selections of vertices from the DAG. For example, a binary number b11010001 may correspond to the vertices 1, 2, 4 and 8, as those bits are ones and the other bits are zeros. Phrased differently, the set {1,2,4,8} may be represented as a binary number/array/vector b11010001 Other possibilities of exactly how to represent each vertex (as zeros, or ones, in what order, with what integers, etc.) are of course also true, but will not be included/considered in what follows.

A benefit of such a representation is that set operations such as union (U) and intersection (n) may be represented by binary/bitwise OR and AND operations. For example, a union of the set {1,2,7} and the set {1,3,6}, i.e. {1,2,7} u {1,3,6}={1,2,3,6,7} may thus be represented as the bitwise operation b11000010 OR b10100100 that equals b11100110 (i.e. {1,2,3,6,7}. Likewise, the operation of intersection (e.g. for {1,2,7}∩{1,3,6}={1}) may be represented as the bitwise operation b11000010 AND b10100100 that equals b10000000 (i.e. {1}). Likewise, a set difference operation (\) may be implemented by considering that A\B=A∪B, where B is the complement of set B. Using the binary number representation, such an operation (e.g. {1,2,7}\{1,3,6}={2,7} may thus be represented as the bitwise operation b11000010 AND (¬b10100100)=b11000010 AND b01011011 that equals b01000010 (i.e. {2,7}).

By using such binary number/vector representations of sets, the methods and corresponding algorithms envisaged and described herein can be efficiently implemented on computer hardware. With reference to FIG. 8, the results of a validation test in which new vertices were added to a distributed ledger as envisaged herein will now be described in more detail. Here, for each time step t, a new source vertex-specific linking set Ct was generated (for the last added vertex) and stored in memory. FIG. 8 schematically illustrates the first 29 such source vertex-specific linking sets, i.e. C₁ through C₂₉, as well as an additional set C₃₀ added for the 30th vertex added at t=30. The length of each set-vector (binary number) Cⱼ was selected to accomplish as many vertices therein as required. In FIG. 8, any trailing zeros of a binary number has been removed and replaced with a star (*)-symbol.

After having added the 30th vertex, at t=30, the source vertices of the DAG were vertices 27, 29 and 30, i.e. V_{sources}={27,29,30}. To find all fully confirmed vertices, in accordance with what have been described herein, the intersection of the source vertex-specific linking sets C₂₇, C₂₉ and C₃₀ are studied, i.e. C₂₇∩C₂₉∩C₃₀. Using the binary representations, this corresponds to a bitwise AND-operation between the binary numbers indicated as 827, 829 and 830 in FIG. 8. The results of such a bitwise AND operation is shown at the bottom of FIG. 8, indicating that the set of fully confirmed sites is equal to {1,2,3,4,5,6,7,8,9,11,13,18}.

In a real-world implementation of a DAG-based distributed ledger as envisaged herein, it is not necessary to store all the previously calculated source vertex-specific linking sets Cⱼ. In general, when a new vertex is added to the DAG, a new source vertex-specific linking set is added for the new vertex and one or more AND operations are used on one or more recent such sets in a table such as that in FIG. 8. Other source vertex-specific linking sets added more previously are not likely used (e.g. the ones further towards the top of the table/pyramid shown in FIG. 8), with the result that the more upper sets of e.g. FIG. 8 as well as the more left bits of each binary number remains unchanged and redundant, and the storage of these elements are therefore not necessarily required. These elements may be considered to belong to an immutable part of the table and corresponds to an irrevocable part of the registry (DAG), because each new source vertex will indirectly confirm the vertices corresponding to these elements. Consequently, only a few dozens of source vertex-specific linking sets/binary numbers Cⱼ are required to store in memory, wherein the exact number may e.g. depend on the characteristics of the peer-to-peer network used to jointly establish and maintain the ledger. The left part of each later binary number, containing only ones (“1”) are also redundant, which may be used to e.g. more efficiently compress the data before storing and/or to remove these elements from storage. For example, a binary number may be stored together with e.g. a single integer indicating to which vertex the first bit of the binary number belongs, and this single integer may be larger than one.

Using the example of FIG. 8 as an example of the above, it can be seen that after having added 30 vertices to the DAG, the system stabilizes and the number of elements on the left side of each binary number/vector will grow at approximately the same speed as the number of newly added vertices on the right side of the binary number/vector. This corresponds to an indication that the number of vertices becoming fully confirmed is approximately equal to a number of new vertices added to the ledger at each time instance. Thus, only a smaller part of each binary number (as indicated by the box 840 in FIG. 8) needs to be stored, which allows to limit the amount of memory (such as RAM) required to keep track of graph vertices, while providing high transaction processing speed. In fact, as indicated by the box 840, only a smaller part of the binary number for the 30th vertex is associated with changes in the DAG. New vertices will be added to the right side of the binary numbers, and what will never change will be added to the left side of the binary numbers. There may of course be a possible delay due to e.g. exchanging of messages within the peer-to-peer network, which may require the box 840 to be defined slightly larger than as indicated in FIG. 8. This does, however, not significantly increase the complexity of the calculations involved.

In summary of all of the above, the present disclosure provides an improved way of how to process new vertices added to a DAG, to e.g. determine confirmation ratios for vertices/transactions of a DAG-based distributed ledger and/or to quickly determine what vertices that are fully confirmed, either as determined solely on a single computing node or as determined based on consensus established among multiple computing nodes taking part in forming the distributed ledger. In particular, the proposed methods does not necessarily alter the rest of already established procedures for how to implement a DAG-based distributed ledger, but provides an improved way of determining e.g. confirmation ratios and sets of fully confirmed vertices that enables further scaling of the DAG and processing of a higher amount of transactions per seconds due to the improved scaling performance of the proposed method(s). Overall, this provides an improved data consistency and synchronization across/among the participating computing node entities, and in particularly reduces the hardware requirements for the participating nodes as the proposed method makes it possible to both more quickly and with more constant, and lower, complexity determine accurate and true confirmation ratios as the DAG grows larger and larger as more and more transactions/vertices are added thereto. This in contrast to e.g. contemporary solutions such as IOTA/Tangle, wherein calculation of confirmation ratios (or confirmation confidences) quickly become intractable as the DAG grows, having made required the addition of dedicated, centralized coordinator nodes and the need to make snapshots of the DAG in order to reset the complexity to maintainable levels. With the proposed method(s) herein, the need for such centralized coordinator nodes and reoccurring need for snapshots are eliminated, and the capability of processing more and more new incoming transactions per second is highly improved.

Although features and elements may be described above in particular combinations, each feature or element may be used alone without the other features and elements or in various combinations with or without other features and elements. Additionally, variations to the disclosed embodiments may be understood and effected by the skilled person in practicing the claimed invention as defined by the appended patent claims, from a study of the drawings, the disclosure, and the appended claims themselves. In the claims, the words “comprising” and “including” does not exclude other elements, and the indefinite article “a” or “an” does not exclude a plurality. The mere fact that certain features are recited in mutually different dependent claims does not indicate that a combination of these features cannot be used to advantage.

What is claimed is:

1. A method of processing new vertices of a directed acyclic graph, DAG, —based distributed ledger using a computing node, the method comprising repeatedly obtaining data indicative of new vertices added or to be added to a DAG, wherein each new vertex directly links to one or more other vertices of the DAG and is added to the DAG as a source vertex, wherein a source vertex is defined as a vertex that is not directly linked to from any other vertex of the DAG, the method further comprising, in response to each new vertex being added to the DAG and using processing circuitry of the computing node:
determining current source vertices of the DAG after adding the new vertex;
determining a linking of the current source vertices to not yet fully confirmed vertices of the DAG, wherein a vertex not being fully confirmed comprises the vertex being neither directly nor indirectly linked to from all source vertices of the DAG before adding the new vertex, and
determining, based on the determined linking of the current source vertices to the not yet fully confirmed vertices, that at least one vertex of the not yet fully confirmed vertices is directly or indirectly linked to from all the determined current source vertices and, in response thereto, treating the at least one vertex as fully confirmed when processing a next new vertex added or to be added to the DAG.

2. The method according to claim 1, wherein:
determining the linking of the current source vertices to the not yet fully confirmed vertices comprises, for each of the not yet fully confirmed vertices, updating a respective unconfirmed vertex-specific linking set comprising indications of source vertices directly or indirectly linking to the specific not yet fully confirmed vertex, by replacing therein indications of any of the one or more other vertices directly linked to from the new vertex with an indication of the new vertex.

3. The method according to claim 2, wherein the method further comprises removing unconfirmed vertex-specific linking sets for vertices having been determined to be fully confirmed.

4. The method according to claim 2, wherein:
determining the current source vertices comprises updating a source vertices set comprising indications of source vertices of the DAG, by removing therefrom indications of any of the one or more other vertices linked to from the new vertex and adding thereto an indication of the new vertex, and
determining that the at least one vertex of the not yet fully confirmed vertices is directly or indirectly linked to from all the determined current source vertices comprises at least one of:
i) determining that the corresponding unconfirmed vertex-specific linking set and the source vertices set have a same cardinality, and
ii) determining that the corresponding unconfirmed vertex-specific linking set and the source vertices set are equal.

5. The method according to claim 2, wherein:
determining the current source vertices comprises updating a source vertices set comprising indications of source vertices of the DAG, by removing therefrom indications of any of the one or more other vertices linked to from the new vertex and adding thereto an indication of the new vertex, and
wherein the method further comprises determining a confirmation ratio for at least one vertex of the not yet fully confirmed vertices, wherein determining the confirmation ratio comprises at least one of:
i) determining a ratio of a cardinality of the corresponding unconfirmed vertex-specific linking set to a cardinality of the source vertices set, and
ii) determining a ratio of a cardinality of an intersection of the corresponding unconfirmed vertex-specific linking set and the source vertices set to a cardinality of the source vertices set.

6. The method according to claim 1, wherein:
determining the linking of the current source vertices to the not yet fully confirmed vertices comprises defining, for the new vertex, a source vertex-specific linking set comprising indications of all not yet fully confirmed vertices directly or indirectly linked to from the new vertex.

7. The method according to claim 6, wherein the source vertex linking set for the new vertex is defined by adding indications of the one or more other vertices directly linked to from the new vertex to a union of corresponding source vertex linking sets for the one or more other vertices.

8. The method according to claim 6, wherein the method further comprises removing source vertex-specific linking sets for one or more previous source vertices directly linked to from the new vertex.

9. The method according to claim 6, wherein:
determining that the at least one vertex of the not yet fully confirmed vertices is directly or indirectly linked to from all the determined current source vertices comprises determining that the at least one vertex is indicated in a corresponding source vertex-specific linking set for each of the determined current source vertices.

10. The method according to claim 6, wherein the method further comprises determining a confirmation ratio for at least one vertex of the not yet fully confirmed vertices, wherein determining the confirmation ratio comprises determining a ratio of a number of corresponding source vertex-specific linking sets of the determined current source vertices in which the at least one vertex is indicated to a total number of determined current source vertices.

11. The method according to claim 6, wherein the method further comprises determining a set of fully confirmed vertices as an intersection of corresponding source vertex-specific linking sets of the determined current source vertices.

12. The method according to claim 2, wherein:
source vertices of the DAG are indicated using integers, each source vertex being provided with a unique such integer, and
each unconfirmed vertex-specific linking set is represented as a binary number, each source vertex of the set corresponding to a particular bit of said binary number, and the particular bit being identifiable based on the integer used to indicate the corresponding source vertex.

13. The method according to claim 12, wherein union and/or intersection operations involving unconfirmed vertex-specific linking sets are performed as corresponding OR and/or AND operations on the binary numbers used to represent the sets.

14. The method according to claim 6, wherein:
not yet fully confirmed vertices of the DAG are indicated using integers, each vertex being provided with a unique such integer, and
each source vertex-specific linking set is represented as a binary number, each not yet fully confirmed vertex of the set corresponding to a particular bit of said binary number, the particular bit being identifiable based on the integer used to indicate the corresponding not yet fully confirmed vertex.

15. The method according to claim 14, wherein union and/or intersection operations involving source vertex-specific linking sets are performed as corresponding OR and/or AND operations on the binary numbers used to represent the sets.

16. The method according to claim 1, wherein the computing node forms part of a plurality of interconnected computing nodes configured to jointly implement the DAG-based distributed ledger, and wherein the computing node operates on its own local copy of the DAG.

17. The method according to claim 16, wherein:
treating the at least one vertex as fully confirmed comprises obtaining one or more indications that the at least one vertex is also determined to be fully confirmed by at least a finite number of the plurality of computing nodes.

18. The method according to claim 16, wherein the method further comprises:
in response to determining that the at least one vertex is directly or indirectly linked to from all determined current source vertices, inserting the at least one vertex into a pool of fully confirmed vertices accessible to the plurality of computing nodes, and
wherein treating the at least one vertex as fully confirmed is performed in response to a consensus being reached among the plurality of computing nodes about the at least one vertex being fully confirmed.

19. A computing node entity for processing new vertices of a directed acyclic graph, DAG, —based distributed ledger, the computing node entity comprising processing circuitry, the processing circuitry being configured to cause the computing node entity to repeatedly obtain data indicative of new vertices added or to be added to a DAG, wherein each new vertex directly links to one or more other vertices of the DAG and is added to the DAG as a source vertex, wherein a source vertex is defined as a vertex that is not directly linked to from any other vertex of the DAG, the processing circuitry being further configured to cause the computing node entity to, in response to each new vertex being added to the DAG:
determine current source vertices of the DAG after adding the new vertex;
determine a linking of the current source vertices to not yet fully confirmed vertices of the DAG, wherein a vertex not being fully confirmed comprises the vertex being neither directly nor indirectly linked to from all source vertices of the DAG before adding the new vertex, and
determine, based on the determined linking of the current source vertices to the not yet fully confirmed vertices, that at least one vertex of the not yet fully confirmed vertices is directly or indirectly linked to from all the determined current source vertices and, in response thereto, treating the at least one vertex as fully confirmed when processing a next new vertex added to the DAG.

20. A computer program product for processing new vertices of a directed acyclic graph, DAG, —based distributed ledger, comprising a non-transitory computer readable storage medium storing computer code which, when executed by processing circuitry of a computing node entity, causes the computing node entity to repeatedly obtain data indicative of new vertices added or to be added to a DAG, wherein each new vertex directly links to one or more other vertices of the DAG and is added to the DAG as a source vertex, wherein a source vertex is defined as a vertex that is not directly linked to from any other vertex of the DAG, the computer code being further configured to cause the computing node entity to, in response to each new vertex being added to the DAG:
determine current source vertices of the DAG after adding the new vertex;
determine a linking of the current source vertices to not yet fully confirmed vertices of the DAG, wherein a vertex not being fully confirmed comprises the vertex being neither directly nor indirectly linked to from all source vertices of the DAG before adding the new vertex, and
determine, based on the determined linking of the current source vertices to the not yet fully confirmed vertices, that at least one vertex of the not yet fully confirmed vertices is directly or indirectly linked to from all the determined current source vertices and, in response thereto, treating the at least one vertex as fully confirmed when processing a next new vertex added to the DAG.
